(19) United States
(12) Patent Application Publication
(10) Pub. No.: US 2010/0004949 A1
(43) Pub. Date: Jan. 7, 2010

(54) METHOD, SYSTEM, AND COMPUTER PROGRAM PRODUCT FOR RECEIVING, EXTRACTING, AND TRANSLATING INTRAOPERATIVE NEUROPHYSIOLOGIC MONITORING (IONM) DATA FROM MULTIPLE DEVICE TYPES

(75) Inventor: Richard A. O'Brien, Westminster, MD (US)

Correspondence Address: VENABLE LLP, P.O. BOX 34385, WASHINGTON, DC, 20043-9998, US

(73) Assignee: IMPULSE MONITORING, INC., Columbia, MD (US)

(21) Appl. No.: 12/167,818

(22) Filed: Jul. 3, 2008

(51) Int. Cl. G06Q 50/00; G06F 17/30

(52) U.S. Cl. 705/3; 707/1; 707/E17.002

(57) ABSTRACT

A computer-implemented system, method, and/or computer program product for translating intraoperative neurophysiologic monitoring (IONM) data obtained from multiple commercially available but incompatible IONM device types. The module includes the functions of receiving the IONM data (including IONM event data) from at least one IONM device during a surgery being monitored and interacting with an individual to obtain additional information (e.g., patient, insurance, billing, accounting, research data, etc.). The module can also extract pertinent information from the IONM data and the additional information and translate the pertinent information into a translated pertinent information in a platform independent format. The module can also report the translated pertinent information (including business and clinical reports).

### BACKGROUND OF THE INVENTION

### Field of the Invention

The present invention relates generally to the process of data collection following intraoperative neurophysiologic monitoring (IONM).

### SUMMARY OF THE INVENTION

An exemplary embodiment of the present invention sets forth various exemplary systems, methods and computer program products. An exemplary method may be used for standardizing transfer, storage, and/or access of intraoperative neurophysiologic monitoring (IONM) data including augmenting with additional information including numeric, procedural, patient, demographic, accounting, and/or billing data electronically from a procedure site, calculation and production of various standardized forms including, e.g., but not limited to, billing and charge sheets, professional (physician) reporting, clinical data, research data, outcome data and employee performance data and for the integration and utilization of this data with associated database collections to extend its utility.

An exemplary embodiment of the current invention may include allowing a uniform method for collecting intraoperative neurophysiologic monitoring (IONM) data from a variety of intraoperative neurophysiologic monitoring (IONM) machines.

Another exemplary embodiment may include mitigating the costs and errors of utilizing a dispersed and/or varied group of IONM machines for professional reporting and/or billing of services.

It is a feature of another exemplary embodiment to provide a way of integrating IONM data with other clinical and non-clinical data that may improve quality assurance and operational activities for an IONM service provider.

The technology of the present invention as explained below can be implemented all at once or in stages. Thus the technology, as explained below, may be available to IONM providers in separate components to allow for the fact that they may not be able to implement the technology all at once.

The extraction and reporting module according to an exemplary embodiment can be used independently to standardize reporting and forms production while acting as a vessel for carrying IONM data in a standardized format.

The database in an exemplary embodiment can be implemented immediately or later on while still allowing for the easy mining of data previously collected by the extraction and reporting modules.

In an exemplary embodiment of the present invention a system, method and computer program product for providing the capture, translation, transfer and reporting of intra-operative neurophysiologic monitoring data from multiple device types is disclosed.

The present invention may include a portable extraction and reporting program, which may be able to recognize the associated monitoring device, may extract the pertinent data, may interact with the technologist on site in the operating room to acquire additional data of interest including, e.g., billing and/or medical coding data, and may transport that data, e.g., electronically over a network, e.g. a virtual private network (VPN), to a centralized, peer-to-peer, or other storage facility. This program may also provide a stand alone report generation ability so that data from any type of IONM machine can be reported in a standardized manner.

Once transported to the centralized facility, the mapped data may be integrated into, e.g., an associated relational database. This database may allow for easy integration into billing systems and other backoffice systems and may allow for the database functionalities of cumulative and filtered reporting over a group of cases instead of just one.

An exemplary embodiment may include an application built atop a MICROSOFT EXCEL® development platform for the extraction and reporting tool for several reasons including ubiquity, built in mathematical, spatial and logical calculations, programmability with VISUAL BASIC FOR APPLICATIONS®, easy electronic transmit ability, integration with industry standard databases, ability to contain information independently of a database, formatting ability for forms construction and ease of incremental development. For instance, the TECHFORM copyrighted application, available from IMPULSE MONITORING INC. of Columbia, Md., USA may include a specific MICROSOFT EXCEL® spreadsheet, which may be used for, e.g., but not limited to, transfer of IONM numeric, procedural, demographic and/or billing data electronically from the procedure site; may be used for the calculation and production of various standardized forms including, but may not be limited to, billing and charge sheets, professional (e.g., physician) reporting, clinical and/or outcome data, employee performance; and/or may used for the interface of data with associated database collections. FIGS. 4A and 4B depict an exemplary workflow according to an exemplary embodiment of the present invention. One exemplary embodiment of a system that may operate as disclosed, may include the exemplary Techform application depicted herein.

Once uploaded to the centralized facility, the overseeing physician can open the portable extraction and reporting tool, may note important data changes or technologist performance issues, and may execute/extract/analyze/publish a report. The data contained within the tool can be left for later retrieval, transferred to and/or stored to the relational database.

Exemplary embodiments of the present invention may provide methods for examining technologist, surgeon and equipment performance across an institution or across a plurality of providers.

Exemplary embodiments of the present invention may provide for automated calculation of billing codes and production of billing forms and employee time sheets.

Exemplary embodiments of the present invention may provide methods for capturing additional clinical data, insurance data and/or patient consent data.

Exemplary embodiments of the present invention may provide methods for capturing initial patient outcome data for clinical research.

Exemplary embodiments of the present invention may provide methods for linking of performed services back to electronic scheduling programs.

Exemplary embodiments of the present invention may allow for automated delivery of an intraoperative neurophysiologic monitoring report to a hospital, a medical care location, or associated clinical personnel via electronic means such as, e.g., but not limited to, email, fax, SMS, MMS, alert notification, IM, other communication, etc., thereby reducing the time for receiving reports.

Exemplary embodiments of the present invention may allow for automated parsing of events recorded during a monitoring period to identify frequency of the events across a group of surgeries.

Exemplary embodiments of the present invention may allow for implementation of data capture before database construction with ability to mine, or re-mine data not originally captured during data transfer to associated databases.

An exemplary embodiment of the invention sets forth a computer-implemented method of translating intraoperative neurophysiologic monitoring (IONM) data obtained from multiple IONM device types. According to an exemplary embodiment, the method may include: receiving IONM data from at least one IONM device regarding a surgery being monitored; interacting with an individual to obtain additional information regarding the surgery being monitored; extracting pertinent information from the IONM data and the additional information; and translating the pertinent information into translated pertinent information in a platform independent format.

According to one exemplary embodiment, the method may further include: communicating the translated pertinent information over a network to at least one of a database or a user.

According to one exemplary embodiment, the method may further include: processing data from the database to produce reporting information.

According to one exemplary embodiment, the processing may include any combination of: analyzing; capturing; correlating; compiling; mining; aggregating; converting into the platform independent format; translating data from a proprietary IONM device specific format to the translated pertinent information in the platform independent format; accumulating; or augmenting.

According to one exemplary embodiment, the reporting may include any combination of: backoffice processing; providing information to or obtaining information from accounting systems; providing information to or obtaining information from billing systems; providing information to or obtaining information from insurance applications; providing information to or obtaining information from patient data applications; providing information to or obtaining information from collections applications; providing research reports; providing business research reports; providing business competitive information; providing business utilization information; or providing clinical research report information.

According to one exemplary embodiment, the method may further include reporting the translated pertinent information.

According to one exemplary embodiment, the additional information may include any combination of: a type of IONM device; a type of device implanted in a patient; clinical information; patient information; insurance information; demographic information; medical record data; surgeon name; surgeon information; physician information; early outcome data; preoperative data; post-operative data; outcome scales; outcomes allowed; IONM event data; IONM event data tied to preoperative condition; IONM event data tied to postoperative condition; baseline data; IONM baseline data; anesthesiology data; scale preoperative data; scale postoperative data; or other information regarding the surgery being monitored.

According to one exemplary embodiment, the interacting may include interacting with at least one of a technician, a technologist, a patient, a physician, a surgeon, a provider, a care giver, a care provider, or a medical professional.

According to one exemplary embodiment, the translating may include translating data from a format associated with each of the multiple IONM devices types into the platform independent format.

According to another exemplary embodiment, a system of translating intraoperative neurophysiologic monitoring (IONM) data being obtained from multiple IONM device types is set forth. According to one exemplary embodiment, the system may include: means for receiving the IONM data from at least one IONM device regarding a surgery being monitored; means for interacting with an individual to obtain additional information regarding the surgery being monitored; means for extracting pertinent information from the IONM data and the additional information; and means for translating the pertinent information into translated pertinent information in a platform independent format.

According to one exemplary embodiment, the system may further include means for reporting the translated pertinent information.

According to another exemplary embodiment, a system for receiving, extracting, and translating intraoperative neurophysiologic monitoring (IONM) data from a plurality of IONM devices of different IONM device format types is set forth. According to one exemplary embodiment, the system may include: at least one IONM device operable to receive IONM data of a patient regarding a surgery being monitored and performed on the patient; an extraction module operable to extract the IONM data from the at least one IONM device and operable to translate the IONM data into a translated platform independent format; a network, coupled to the at least one IONM device, operable to communicate the IONM data; and a database coupled to the network, wherein the database is operable to at least one of store or access the IONM data.

According to one exemplary embodiment, the system may include where at least one IONM device is located at a remote site.

According to one exemplary embodiment, the system may include where the database any combination of stores or accesses the IONM data and is operable to provide semi-automatic reporting.

According to one exemplary embodiment, the system may further include an ability to augment the IONM data with additional information comprising at least one of: patient identifying information, intraoperative neurophysiologic monitoring event data, preoperative data, postoperative data, demographic data of the patient, insurance data, backoffice application information, accounting information, supply information, inventory information, device information, collections information, physician information, statistical information, medical facility information, care provider information, or billing information.

According to one exemplary embodiment, the system may further include an analysis module operable to analyze the IONM data.

According to one exemplary embodiment, the translating may include a computer program product for translating intraoperative neurophysiologic monitoring (IONM) data from multiple IONM device types. According to one exemplary embodiment, the computer program product may be embodied on a computer accessible medium, and the computer program product may include program logic, which when executed on a computer processor, performs a method which may include, in an exemplary embodiment: receiving the IONM data from a IONM device; interacting with an individual to obtain additional information; extracting pertinent information from the IONM data and the additional information; and translating the pertinent information into a platform independent format.

According to one exemplary embodiment, the computer program product's method may further include: reporting the pertinent information.

According to one exemplary embodiment, the computer program product's method may further include: communicating the translated pertinent information over a network to a database.

According to one exemplary embodiment, the computer program product's method may further include: processing data from a database to produce reports comprising at least one of: a business report; an accounting report; a billing report; an insurance report; a patient report; a collections report; a competitive report; a utilization report; or a clinical research report.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of the flow of data according to an exemplary embodiment of the present invention;

FIG. 2 depicts an exemplary embodiment of the workflow process according to an exemplary embodiment of the present invention;

FIG. 3 depicts an exemplary embodiment of a computer environment according to an exemplary embodiment of the present invention; and

FIGS. 4A and 4B collectively depict an exemplary embodiment of a workflow process according to an exemplary embodiment of the present invention.

### EXEMPLARY DEFINITIONS

In describing the invention, the following definitions may be applicable throughout (including above).

A “network” may refer to a number of computers and associated devices that may be coupled and/or connected by communication facilities. A network may involve permanent connections such as cables or temporary connections such as those that may be made through telephone or other communication links. A network may further include hard-wired connections (e.g., coaxial cable, twisted pair, optical fiber, waveguides, etc.) or wireless connections (e.g., radio frequency waveforms, free-space optical waveforms, acoustic waveforms, satellite transmissions, infrared communications, wireless communications, line-of-sight, etc.). Examples of a network may include: an internet, such as the worldwide Internet; an intranet; a local area network (LAN); a wide area network (WAN); a metropolitan area network; a personal area network; a wireless network; a private and/or public network; and a combination of networks, such as, e.g., but not limited to, an internet and an intranet. Exemplary networks may operate with any of a number of protocols, such as, e.g., but not limited to, Internet protocol (IP), transmission control protocol (TCP), asynchronous transfer mode (ATM), or synchronous optical network (SONET), user datagram protocol (UDP), IEEE 802.x, 802.11, 802.16, etc.

A “computer” may refer to one or more apparatus or one or more systems that are capable of accepting a structured input, processing the structured input according to prescribed rules, and producing results of the processing as output. Examples of a computer may include: a computer; a stationary or portable computer; a computer having a single processor, multiple processors, or multi-core processors, which may operate in parallel or not in parallel; a general purpose computer; a special purpose computer; a supercomputer; a mainframe; a super mini-computer; a mini-computer; a workstation; a micro-computer; a server; a client; an interactive television; a web appliance; a thin client; a fat client; a network appliance; a communications device; a telecommunications device with internet access; a hybrid combination of a computer and an interactive television; a portable computer; a tablet personal computer (PC); a personal digital assistant (PDA); a portable device; a portable telephone; a telephony device; application-specific hardware to emulate a computer or software, such as, for example, a digital signal processor (DSP), a field-programmable gate array (FPGA), an application specific integrated circuit (ASIC), an application specific instruction-set processor (ASIP), a chip, chips, or a chip set; a system-on-chip (SoC) or a multiprocessor system-on-chip (MPSoC); an optical computer; a quantum computer; a biological computer; and an apparatus that may accept data, may process data in accordance with one or more stored software programs, may generate results, and typically may include input, output, storage, arithmetic, logic, and/or control units.

“Software” may refer to prescribed rules, modules, logic, code, instructions, applications, etc., to operate a computer or a portion of a computer. Examples of software may include, e.g., but are not limited to: applications; routines; modules; objects; classes; object-oriented code; JAVA; methods; functions; code segments; instructions; applets; source code; object code; executable code; pre-compiled code; compiled code; interpreted code; computer programs; and/or programmed logic.

A “computer-readable medium” may refer to any storage device used for storing data accessible by a computer. Examples of a computer-readable medium may include, e.g., but are not limited to: a magnetic hard disk; a floppy disk; an optical disk, such as a CD-ROM and a DVD; a magnetic tape; a memory chip; magneto-optical devices; write once read many (WORM); a storage area network (SAN); a volume; a virtual disk; or other types of media that can store machine-readable instructions thereon. A “computer system” may refer to a system which may include, one or more computers, where each computer may include a computer-readable medium embodying software to operate the computer. Examples of a computer system may include, e.g., but may not be limited to: a distributed computer system for processing information via computer systems linked by a network; two or more computer systems connected or coupled together via a network or other communications device for transmitting or receiving information between the computer systems; and one or more apparatuses or one or more systems that may accept data, may process data in accordance with one or more stored software programs, may generate results, and typically may include, e.g., but not limited to, input, output, processing, storage, branching, arithmetic, logic, and/or control units.

Exemplary Abbreviations

| | |
|---|---|
| AMR | Abnormal Muscle Response |
| BAER, AER | Brainstem Auditory Evoked Responses |
| CAP | Compound Action Potential |
| CMAP | Compound Muscle Action Potentials |
| DECS | Direct Electrical Cortical Stimulation |
| ECoch, ECoG | Electrocochleogram |
| EMG | Electromyography |
| ENT | Ear Nose and Throat Surgery (Otolaryngology) |
| EPs | Evoked Potentials |
| IOM, INM | Intraoperative Neurophysiological Monitoring |
| ION | Intraoperative Neurophysiology |
| IS | Idiopathic Scoliosis |
| MEP | Motor Evoked Potentials |
| MIOM | Multi-modality Intraoperative Monitoring |
| M-SEP | Median Nerve Somatosensory Evoked Potentials |
| NMEP | Neurogenic Motor Evoked Potentials |
| NPV | Negative Predictive Value |
| PPV | Positive Predictive Value |
| S-EMG | Spontaneous EMG |
| SCEP | Sensory Cord Evoked Potentials |
| SEP, SSEP | Somatosensory Evoked Potentials |
| T-EMG | Triggered or Evoked Electromyography |
| TCD | Trans-cranial Doppler |
| TceMEP | Transcranial Electrical Motor Evoked Potentials |
| T-SEP | Tibial Nerve Somatosensory Evoked Potentials |
| TES, TCES | Transcranial Electrical Stimulation |
| UH, UHC | UnitedHealthcare, Inc. |

Glossary

| | |
|---|---|
| dura mater | the tough fibrous membrane that |
| | envelops the brain and spinal cord |
| epidural | situated upon or administered outside the dura mater |
| extubation | the removal of the tube after |
| | intubation of the larynx or trachea |
| hyperesthesia | increased sensitivity to stimulation |
| kyphosis | abnormal backward curvature of the spine |
| latency | delay period between stimulus and response for SSEP |
| percutaneous | effected or performed through the skin |
| scoliosis | a lateral curvature of the spine |
| sequelae | an after effect of disease or injury |

### Detailed Description of Various Exemplary Embodiments of the Present Invention

Various exemplary embodiments including a preferred embodiment of the invention are discussed in detail below. While specific exemplary embodiments are discussed, it should be understood that this is done for illustration purposes only. A person skilled in the relevant art will recognize that other components and configurations can be used without parting from the spirit and scope of the invention.

The current invention may include a method, system, and/or computer program product for capturing, translating, transferring, storing and reporting information from more than one site having any commercially available intraoperative neurophysiologic monitoring (IONM) device or devices and may couple that information with other operational information within the company to dramatically improve the utility of the information by improving efficiency, automating downstream processes and improving quality of care.

An exemplary embodiment of the present invention is directed to a method, system, and/or computer program product for the collection of intraoperative neurophysiologic monitoring (IONM) information and data from multiple types of IONM devices which may be in geographically dispersed sites, storing and/or translating that information into a platform independent format and allowing semi-automated reporting, database storage, indexing, analysis, and/or management of the information and data.

### Overview of Intraoperative Neurophysiologic Monitoring (IONM)

Intraoperative neurophysiologic monitoring (IONM) is the application of a variety of electrophysiological and vascular monitoring procedures during surgery to allow early warning and avoidance of injury to nervous system structures.

The purpose of IONM is to reduce the incidence of iatrogenic (i.e., arising from medical treatment) and randomly induced neurological injuries to patients during surgical procedures. IONM consequently confers benefits at many levels in medical care including improved patient care, reduced patient neurological deficits, improved surgical morbidity (e.g., decreasing the incidence or severity of surgery) and mortality, reduced hospital stay and medical costs and reduced overall insurance burden.

IONM may include administration of one or more of a variety of electrophysiological and vascular procedures or modalities during surgeries where nervous system structures are at risk. IONM procedures have evolved from the original use of single modality monitoring. Around 2001, most IONM equipment could acquire only two or four channels of information. In 2008, technology allows sixteen, or even thirty two channels of data to be monitored for a single case. Even greater channels of data are expected in the nearterm. Somatosensory evoked potentials (SSEP) allow monitoring of the major sensory pathways. Motor evoked potentials, such as, e.g., transcranial electric motor-evoked potential (TceMEP), allow monitoring of the main pathways. Various other modalities are also available including, e.g., but not limited to, electroencephalography (EEG) (monitoring of the brain surface), electromyography (EMG), auditory evoked potentials (AEPs), brain mapping (identification of specific areas of function) and transcranial doppler (monitoring brain blood flow), event related potentials (ERPs), brainstem auditory evoked response (BAER) or brainstem auditory evoked potential (BAEP), electroretinograms (ERG), visual evoked responses (VER or VEP) and electrocochleogram (EcOG). More than one modality may be used during a single surgery.

Monitoring is typically carried out in the operating room by a qualified technologist, supported by a neurologist either nearby, local, or remotely and in real time communication. Following the surgery, the data must be reviewed by the neurologist who then produces a summary report. The IONM data may be stored as part of the patient chart.

Several IONM device manufacturers now produce multi-modality IONM monitoring devices for use in the operating room including, e.g., but not limited to, Cadwell Laboratories of Kennewick, Wash. USA, Xltek of Oakville, Ontario, Canada;

Axon Cellular Neuroscience Instruments of Molecular Devices (MDS) Analytical Technologies of Sunnyvale, Calif., USA; Nicolet Biomedical/Viasys Healthcare Inc. of Cardinal Health of Dublin, Ohio, USA; Nihon Kohden of Tokyo, Japan; etc. Each of these manufacturers use proprietary, incompatible, nonuniform, connectivity, storage and reporting techniques that are centered on each single case which makes it difficult to use more than one type of equipment in any one institution. The many types of devices also impede collection of cumulative data for doing research and measuring quality of care. In most cases there is no provision for coupling the collected data to billing information or medical coding information or any equipment or technologist performance based information.

More recently many hospitals have turned to outsourcing the IONM service due to the costs of maintaining an in-house program, lack of efficiencies and difficulties in obtaining qualified personnel. For IONM service providers now filling this role and servicing several institutions in more than one location and with more than one machine type the problem is compounded. Conventionally, no standardized method for capturing, archiving, data basing, storing, analyzing and reporting intraoperative neurophysiologic monitoring information from more than one location or type of available equipment has been available. Conventionally, no coupling of information with that needed for billing and maintaining quality assurance is available.

An exemplary embodiment of the invention sets forth a standardized method of capturing, storing, indexing, analyzing and reporting information from more than one site with any commercially available intraoperative neurophysiologic monitoring (IONM) device, and coupling that information with other operational information to improve efficiency and address quality of care. Rather than limiting users to proprietary and incomplete solutions provided by a device manufacturer, an intermediary or translating device or system with standardized reporting ability and a data base interface to allow entry of additional related information and rapid examination of a volume of intraoperative neurophysiologic monitoring data is provided.

### Exemplary Embodiment of an Exemplary Integrated Multi-Device Type Intraoperative Neurophysiologic Monitoring (IONM) System

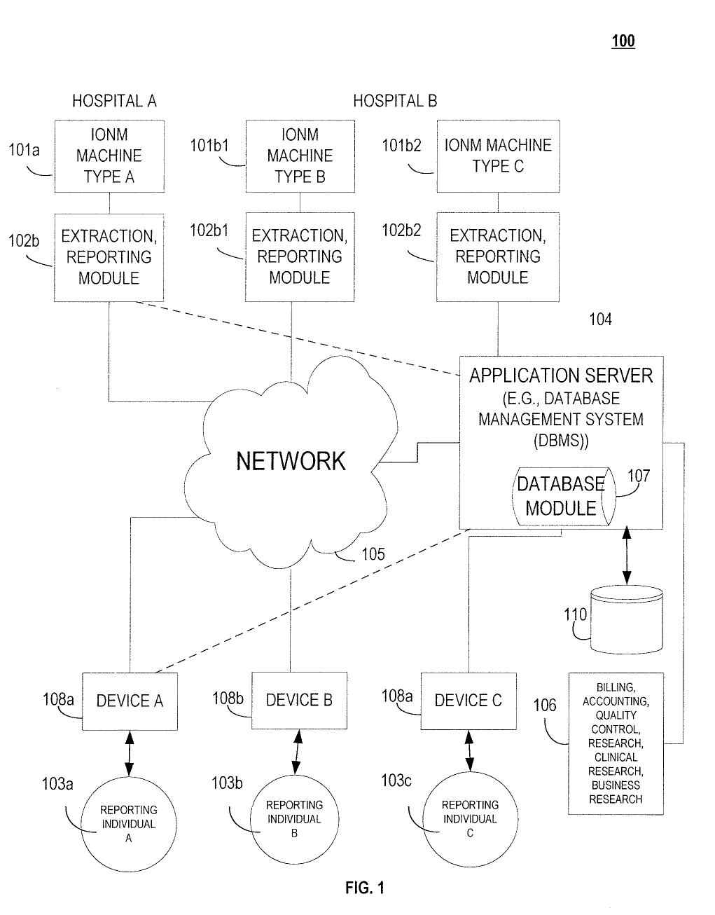

Referring to FIG. 1, diagram 100 provides a depiction of an exemplary hardware architecture illustrating an exemplary embodiment of an exemplary integrated multi-device type intraoperative neurophysiologic monitoring (IONM) system indicating an overall flow of data within the system.

According to an exemplary embodiment, one or more technologists (not shown) may operate one or more IONM devices at, Hospital A (not shown) and Hospital B (not shown). In an exemplary embodiment, a variety of incompatible IONM device type machines 101 may be used. For example, according to an exemplary embodiment, IONM device type A 101a may be used at Hospital A. In an exemplary embodiment, IONM device type B 101b1, and IONM device type C 101b2, may be used at Hospital B, as shown.

The IONM machines or IONM devices A 101a, B 102b1, and C 102b2, may each have their own proprietary and incompatible data format. Intraoperative neurophysiologic monitoring (IONM) data may be acquired from exemplary IONM equipment devices 101a, B 102b1, and C 102b2 (referred to hereinafter collectively as 101) during a surgical procedure.

IONM data monitored by the IONM equipment 101 may be extracted by exemplary extraction reporting modules (ERM) 102bb 102b1 and 102b2 (referred to hereinafter collectively as 102), according to an exemplary embodiment. In another exemplary embodiment, ERM 102 may include a computer software program which may be resident on, and/or execute on a separate ERM 102 device, and may interact with software resident on, and/or executing on the IONM device 101.

In another exemplary embodiment, ERM 102 may be software which may execute on the IONM device 101, itself, while interacting with the software of the IONM device 101 (which is often proprietary) to interpret and transfer the acquired data into a standardized format. Each respective ERM 102 may recognize each corresponding type of IONM device or machine 101, which it is interacting with and may provide an appropriate algorithm for data extraction, translation, and/or conversion.

The ERM 102 may also interact (e.g., electronically) or prompt a monitoring technologist to perform certain interactions. In an exemplary embodiment, any of various individual users may interact or communicate via network 105 such as, e.g., but not limited to, one of reporting individuals A 103a, B 103b, and C 103c (collectively referred to hereinafter as 103) via, e.g., but not limited to, devices A 108a, B 108b, and C 108c, respectively, (collectively referred to hereinafter as 108) of reporting individuals A, B and C.

The reporting individuals 103, via, e.g., devices 108, may complete forms (such as, e.g., electronic forms, etc.) and/or may communicate via other programs to enter additional information such as, e.g., but not limited to, preoperative, intraoperative, and post operative, immediate patient clinical outcome information, other clinical information, patient information, etc., following surgery. Other data and information may also be captured/collected including, e.g., but not limited to, patient information, billing, insurance, demographic, etc.

The ERM 102 may store the associated data for later access or transmission. Alternatively, ERM 102 may communicate or transfer the data by, e.g., a secure electronic or optical communications link, connection or coupling such as, e.g., but not limited to, a virtual private network (VPN) over a network 105 to a centralized file server 104, where the data may be incorporated into a database module 107 of the server 104. According to an exemplary embodiment, data may be encrypted and security may be used to ensure patient and other sensitive information is protected for privacy and other reasons. The data may then be, e.g., but not limited to, immediately, or otherwise, made available to back office applications 106 such as, e.g., but not limited to, billing, accounting, insurance, reporting, collections, and quality assurance, or other reporting or other applications or databases 107, 110.

In one exemplary embodiment, an example reporting individual A 103a may be an overseeing physician. In an exemplary embodiment, e.g., the overseeing physician 103a can log onto a computing device 108a such as, e.g., but not limited to, an application server 104, e.g., remotely as in 103a, 103b via devices 108a, 108b, respectively, or locally as in 103c via device 108c, to access the IONM data from the individual ERM modules 102 and the data may be analyzed or mined, and may be used to produce, e.g., a report, e.g., but not limited to, regarding clinical occurrences during the surgery. The physician 103a may enter comments or may otherwise augment the data, e.g., before or after surgery. The physician's comments in the report may be incorporated into the database module 107, for example. Once data is captured and aggregated, the data placed in database 107 may be used to run reports for such purposes as backoffice applications, billing, research, quality, etc.

The application server 104, although referred to as a server, need not be in a client-server relationship with devices 108, but may use any other communications relationship such as, e.g., but not limited to, a peer-to-peer relationship.

Application server 104 may include a database management system (DBMS) in an exemplary embodiment. In one exemplary embodiment, the DBMS may be a MICROSOFT SQL SERVER available from MICROSOFT CORPORATION of Redmond, Wash. USA. Any of various other well known DBMSs may also be used such as, e.g., but not limited to, ORACLE, DB2, etc. Such data may be stored in records including one or more fields of data per data record. An exemplary data format is included in Table 1, below.

Network 105 may be of any of various well known topologies, a ring, a bus, a star wired ring, an ethernet, token ring, FDDI, etc. Network 105 may be coupled to application server 104 via any of various well known technologies and devices (not shown), including, e.g., but not limited to, one or more router(s), firewall(s), load balancing device(s), web server(s), cabling, fibre, and/or multiplexer/demultiplexer, etc.

Exemplary Enibodinient of Workflow within the Exemplary System

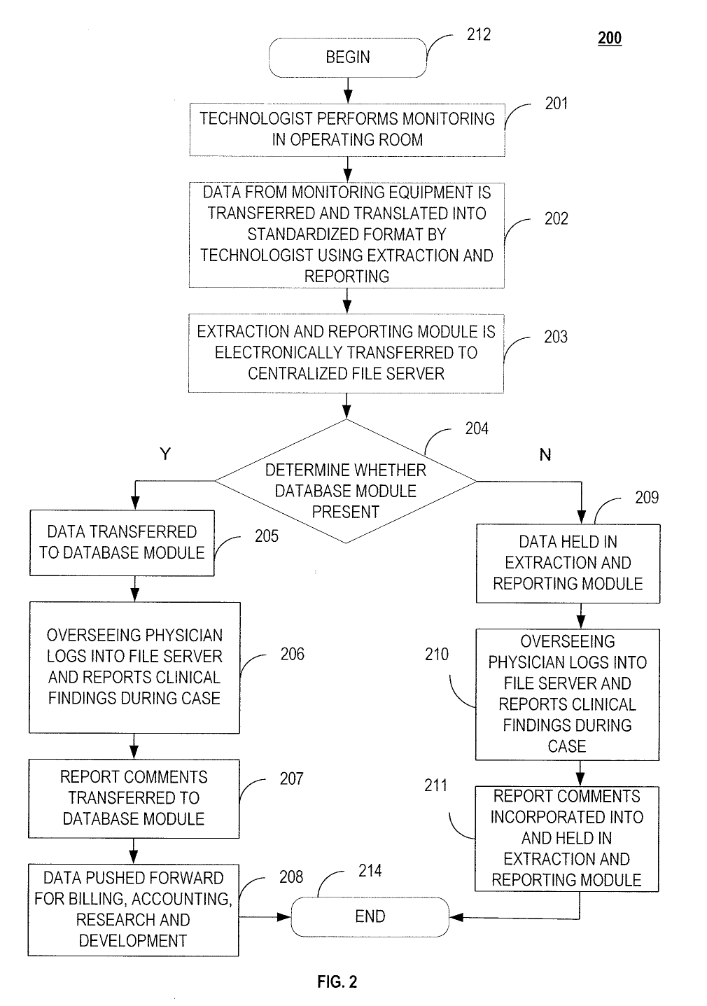

Referring to FIG. 2, a flow diagram 200 illustrating an exemplary view of workflow within the system, is depicted according to an exemplary embodiment. Flow diagram 200 may begin initially with workflow element 212. From 212, flow diagram 200 may continue immediately with 201.

In 201, intraoperative neurophysiologic monitoring (IONM) data may be acquired from one of the exemplary various commercially available IONM machines 101, by, e.g., a technologist performing monitoring, according to an exemplary embodiment. From 201, flow diagram 200 may continue with 201.

In 202, the IONM data may then be extracted by the extraction and reporting module 102 into a standardized unified format. In 202, data from monitoring equipment may be transferred and translated into the standardized format by the technologist using extraction and reporting. In an exemplary embodiment, the standardized format may be the data format depicted in Table 1 below. The technologist may be, e.g., but not limited to, prompted, or requested by the system at that time (or otherwise) to add or enter additional information, which may be made available for other purposes such as, e.g., but not limited to, billing, outcome and/or research purposes. In an exemplary embodiment, various information may be captured including, e.g., but not limited to, a type of monitoring device, a type of device implanted, clinical information, patient information, patient demographics, name, address, surgeon name, early outcome, IONM event data, event data, event data tied to preoperative and post operative condition, baseline data, anesthesia data, scale preoperative, scale postoperative, outcome scales, allowed, reports, accounting, backoffice, billing, insurance, patient, collections information, research, business, competitive information, utilization data, clinical research purpose data, etc. In an exemplary embodiment, data may be augmented. From 202, flow diagram 200 may continue with 203.

In 203, the ERM 102, containing the extraction and interrogation data, may then be transferred electronically (or via an optical or other communications network) to the application server 104. From 203, flow diagram 200 may continue with 204.

In 204, it may be determined whether a database module is present or not. In the event that no database module is present, then flow diagram 200 may continue with 209. If a database module 107 is present, then flow diagram 200 may continue with 205.

In 205, if the database module 107 is present, data within the extraction and reporting module 102 may be transferred to the database 107. From 205, flow diagram 200 may continue with 206.

In 206, the overseeing physician can then log onto the file server 104 and may report the clinical findings of the surgery. The physician's comments may be entered into, e.g., but not limited to, both the extraction and reporting module 102 and the database module 107. From 206, flow diagram 200 may continue with 207.

In 207, information, such as, for example, but not limited to, report comments may be transferred to database 107. From 207, flow diagram 200 may continue with 208.

In 208, data can be pushed forward, e.g., but not limited to, to other applications, databases 107, 110, which may be used for operational purposes including, e.g., but not limited to, regulatory compliance, archive, backoffice operations (e.g., but not limited to, billing, accounting, insurance, patient, collections, etc.), research (e.g., but not limited to, business analysis, competitive analysis, utilization analysis, clinical research, etc.), quality assurance, quality analysis, and/or customer service, etc. From 208, flow diagram 200 may continue with 214. In an exemplary embodiment at 214, flow diagram 200 may immediately end.

In 209, if the database module 107 is not present, the data may remain within the extraction and reporting module 102 for later use. In an exemplary embodiment, data may be held only in the ERM 102 where no database 107 is available. From 209, flow diagram 200 may continue with 210.

From 210 (reference is made to step 206 above), when no database 107 is present, flow diagram 200 may continue with 211.

In 211, report comments may be incorporated into, and/or may be held in the extraction and reporting module. In exemplary embodiment, the ERM 102 may include a database file such as, e.g., but not limited to, a spreadsheet such as, e.g., but not limited to, a MICROSOFT EXCEL spreadsheet application file. From 211, flow diagram 200 may continue with 214, where flow diagram 200 may immediately end, according to an exemplary embodiment.

### Exemplary Enibodinient of Computer Environment

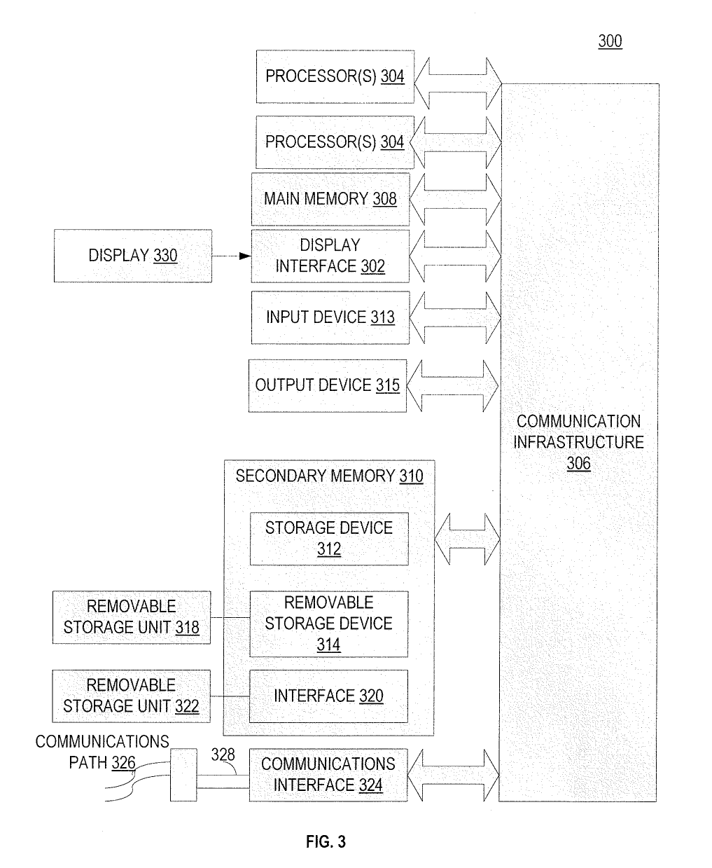

FIG. 3 depicts an exemplary computer system that may be used in implementing an exemplary embodiment of the present invention. Specifically, FIG. 3 depicts an exemplary embodiment of a computer system 300 that may be used in computing devices such as, e.g., but not limited to, a client and/or a server, etc., according to an exemplary embodiment of the present invention. FIG. 3 depicts an exemplary embodiment of a computer system that may be used as client device 300, or a server device 300, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 300 may be shown in FIG. 3, depicting an exemplary embodiment of a block diagram of an exemplary computer system useful for implementing the present invention. Specifically, FIG. 3 illustrates an example computer 300, which in an exemplary embodiment may be, e.g., (but not limited to) a personal computer (PC) system running an operating system such as, e.g., (but not limited to) MICROSOFT® WINDOWS® NT/98/2000/XP/CE/ME/VISTA, etc. available from MICROSOFT® Corporation of Redmond, Wash., USA. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 300 may be shown in FIG. 3. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 3. Services may be provided on demand using, e.g., but not limited to, an interactive television (iTV), a video on demand system (VOD), and via a digital video recorder (DVR), or other on demand viewing system.

The computer system 300 may include one or more processors, such as, e.g., but not limited to, processor(s) 304. The processor(s) 304 may be connected to a communication infrastructure 303 (e.g., but not limited to, a communications bus, cross-over bar, or network, etc.). Various exemplary software embodiments may be described in terms of this exemplary computer system. After reading this description, it may become apparent to a person skilled in the relevant art(s) how to implement the invention using other computer systems and/or architectures.

Computer system 300 may include a display interface 302 that may forward, e.g., but not limited to, graphics, text, and other data, etc., from the communication infrastructure 303 (or from a frame buffer, etc., not shown) for display on the display unit 330.

The computer system 300 may also include, e.g., but may not be limited to, a main memory 308, random access memory (RAM), and a secondary memory 310, etc. The secondary memory 310 may include, for example, (but not limited to) a hard disk drive 312 and/or a removable storage drive 314, representing a floppy diskette drive, a magnetic tape drive, an optical disk drive, a compact disk drive CD-ROM, etc. The removable storage drive 314 may, e.g., but not limited to, read from and/or write to a removable storage unit 318 in a well known manner. Removable storage unit 318, also called a program storage device or a computer program product, may represent, e.g., but not limited to, a floppy disk, magnetic tape, optical disk, compact disk, etc. which may be read from and written to by removable storage drive 314. As may be appreciated, the removable storage unit 318 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and a memory chip, etc.

In alternative exemplary embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 322 and interfaces 320, which may allow software and data to be transferred from the removable storage unit 322 to computer system 300.

Computer 300 may also include an input device 313 such as, e.g., (but not limited to) a mouse or other pointing device such as a digitizer, scanner, touchscreen, and a keyboard or other data entry device.

Computer 300 may also include output devices 315, such as, e.g., (but not limited to) display 330, and display interface 302. Other output devices may include, e.g., but not limited to, printers, touchscreen, projectors, screens, etc.

Computer 300 may further include any of various other well known input/output (I/O) devices such as, e.g., (but not limited to) communications interface 324, cable 328 and communications path 323, routers, firewalls, and load balancing and/or other equipment (not shown), etc. These devices may include, e.g., but not limited to, a network interface card, and modems (neither are labeled). Communications interface 324 may allow software and data to be transferred between computer system 300 and external devices.

In this document, the terms “computer program medium” and “computer readable medium” may be used to generally refer to media such as, e.g., but not limited to removable storage drive 314, a hard disk installed in hard disk drive 312, and signals 328, etc. These computer program products may provide software to computer system 300. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

Exemplary Embodiment of a Workflow Process with Techform

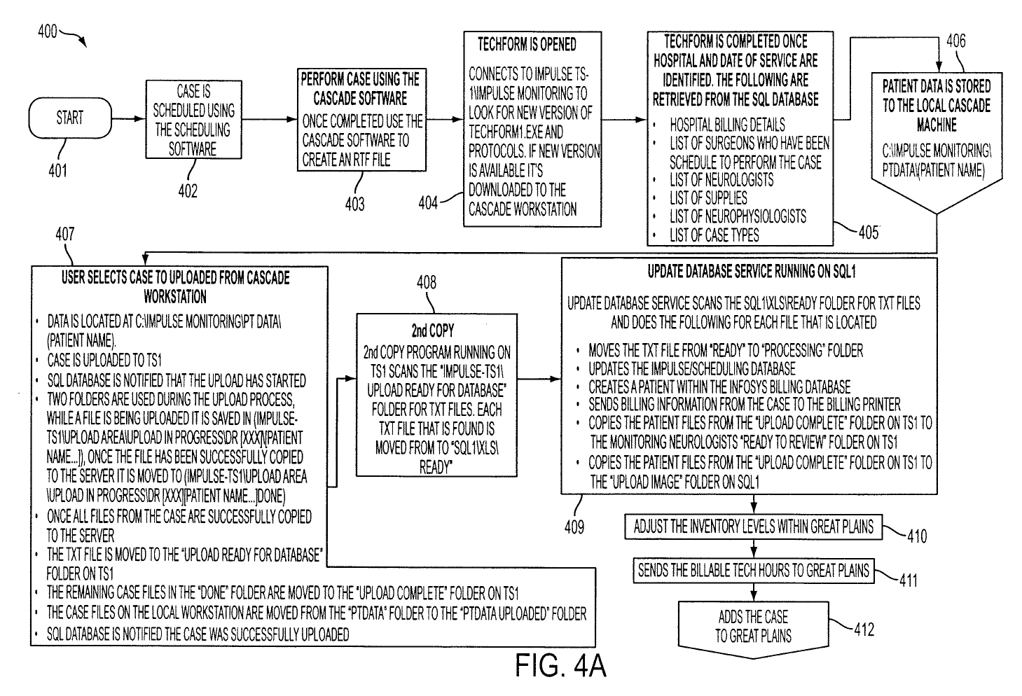

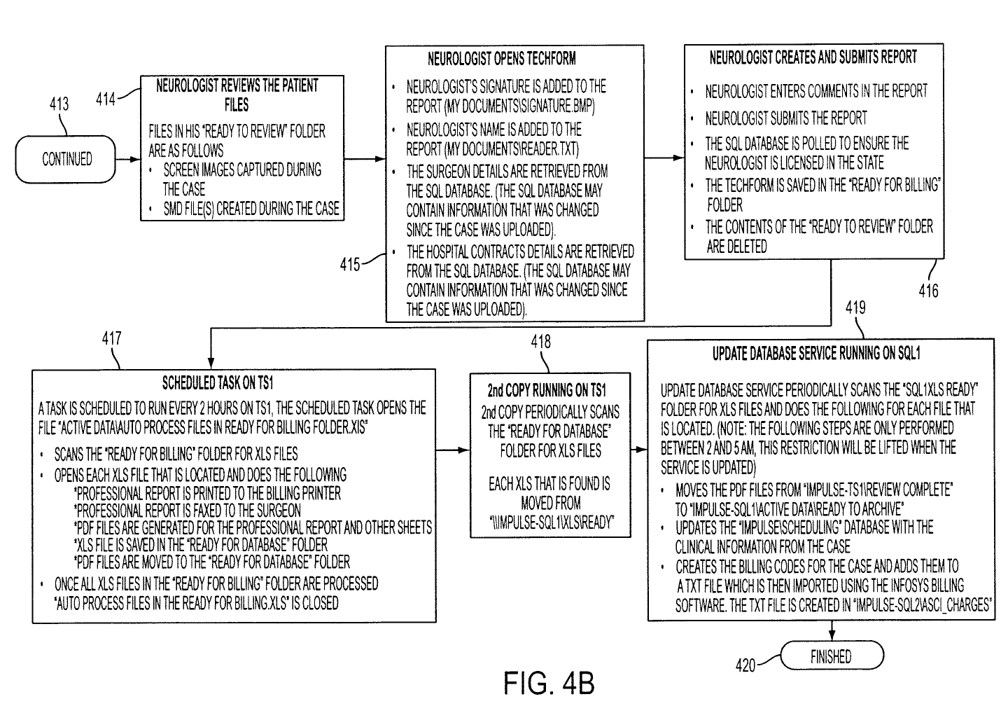

FIGS. 4A and 4B collectively depict an exemplary embodiment of a workflow process diagram 400 according to an exemplary embodiment of the present invention. In an exemplary embodiment, flow diagram 400 may illustrate workflow using an exemplary ERM 102 which may include a Techform application available from IMPULSE MONITORING INC. of Columbia, Md., according to one exemplary embodiment.

Referring to FIG. 4A, a flow diagram 400 illustrating an exemplary view of workflow within the system, is depicted according to an exemplary embodiment. The workflow may begin with the 401. From 401, flow diagram 400 may immediately continue with 402.

In 402, the case may be scheduled using scheduling software, according to an exemplary embodiment. From 402, flow diagram 400 may continue with 403.

In 403, the case may be performed using, e.g., but not limited to, a Cadwell Cascade multi-modality system, software and IONM device 101, running CASCADE® proprietary software available from Cadwell Laboratories, Inc. of Kennewick, Wash. USA. Once this is completed, the Cascade software may be used to create a rich text format (RTF) file, according to an exemplary embodiment. From 403, flow diagram 400 may continue with 404.

In 404, the Techform application may be opened and/or executed. Once the hospital and date of service are identified, the Techform for a given monitoring session may be captured, according to an exemplary embodiment. From 404, flow diagram 400 may continue with 405.

In 405, information may be retrieved from database 107, which according to an exemplary embodiment may include a MICROSOFT Structured Query Language (SQL) server database application 104. The SQL database 107 may include, e.g., but not limited to, hospital billing details, a list of surgeons who have been scheduled to perform a case, a list of neurologists, a list of supplies, a list of neurophysiologists, technologists, and/or a list of case types, according to an exemplary embodiment. From 405, flow diagram 400 may continue with 406.

In 406, according to one exemplary embodiment, the patient and other data may be stored to the local Cascade machine, according to an exemplary embodiment. According to another exemplary embodiment, the data may be stored at another location such as, e.g., but not limited to, database 107, 110, etc. From 406, flow diagram 400 may continue with 407.

In 407, the user may select the case to upload from the Cascade workstation 101, according to an exemplary embodiment. From 407, flow diagram 400 may continue with 408.

In 408, an application program for archive or backup such as, e.g., but not limited to, SECOND COPY® available from Centered Systems of Denver, Colo. USA, may run on TS1, according to an exemplary embodiment. Moving of files and folders may be performed as needed to other secure areas of the network for secure storage or redundant backup or archive. From 408, flow diagram 400 may continue with 409.

In 409, according to an exemplary embodiment, application server 104 may be used to update the database 107, in the diagram, the database may be referred to as SQL1, according to an exemplary embodiment. From 409, flow diagram 400 may continue with 410.

In 410, inventory levels, for example, as well as any other accounting and/or billing data may be adjusted in a backoffice system such as an accounting application such as, e.g., but not limited to, Great Plains accounting application, according to an exemplary embodiment. From 410, flow diagram 400 may continue with 412.

In 411, according to an exemplary embodiment, billable technologist Hours may be captured and may be sent to appropriate back office systems for billing, such as an accounting application program such as, e.g., but not limited to, Great Plains, according to an exemplary embodiment. From 411, flow diagram 400 may continue with 412.

In 412, the case may be added to appropriate back office systems for billing, such as an accounting application program such as, e.g., but not limited to, Great Plains, according to an exemplary embodiment. From 412, flow diagram 400 may continue with 413.

Referring to FIG. 4B, the process may continue with 413, and may proceed immediately to 414.

In 414, a doctor, physician, and/or other individual may review the patient files, according to an exemplary embodiment. From 414, flow diagram 400 may continue with 415.

In 415, the doctor, physician, and/or other individual, may open the Techform, according to an exemplary embodiment. From 415, flow diagram 400 may continue with 416.

In 416, the doctor, physician, and/or other individual may create and/or submit a report, according to an exemplary embodiment. From 416, flow diagram 400 may continue with 417.

In 417, a task may be scheduled to execute on TS1, as depicted, according to an exemplary embodiment. From 417, flow diagram 400 may continue with 418.

In 418, a second copy may execute on TS1 and may periodically scan a folder for files. According to another exemplary embodiment, instead of polling, the system may be event triggered, or interrupt triggered, as will be apparent to those skilled in the relevant art, according to an exemplary embodiment. From 418, flow diagram 400 may continue with 419.

In 419, the database application 107 service executing on application server 104, which may be running on SQL1 may be updated, according to an exemplary embodiment. From 419, flow diagram 400 may continue immediately with 420, and flow diagram 400 may be completed, according to an exemplary embodiment.

The rapid flow of data may make the data immediately available for operational utilization, therefore dramatically improving efficiency, shorting cycle times, improving quality, increasing patient customer satisfaction, enabling improved business and clinical reporting, enabling faster insurance billing, and/or shortening billing and collections time.

### Exemplary Platform Independent Database

TABLE 1

| Database | Table | Field |
|---|---|---|
| impulse | Agent | Agent_ID |
| impulse | Agent | Agent_Name |
| impulse | Agent | Agent_Units |
| impulse | Agent | Case_ID |
| impulse | Agent_Parameter | Agent_ID |
| impulse | Agent_Parameter | Agent_Parameter_ID |
| impulse | Agent_Parameter | Agent_Time |
| impulse | Agent_Parameter | Agent_Value |
| impulse | Agent_Parameter | Agent_Value_Type |
| impulse | Anesthetic | Anesthetist |
| impulse | Anesthetic | Case_ID |
| impulse | Anesthetic | Tech_Comment |
| impulse | Anesthetic | TOF_Performed_By |
| impulse | Billing_Details | Case_ID |
| impulse | Billing_Details | Date_Of_Admission |
| impulse | Billing_Details | Diagnosis |
| impulse | Billing_Details | Fee |
| impulse | Billing_Details | Invoice_Number |
| impulse | Billing_Details | Monitored_OnLine |
| impulse | Billing_Details | Monitoring_Charge |
| impulse | Billing_Details | Neurologist_Involvement |
| impulse | Billing_Details | Purchase_Order |
| impulse | Billing_Details | Service_Date |
| impulse | Billing_Details | Supply_Charge |
| impulse | Billing_Details | Surgical_Procedure |
| impulse | Billing_Details | Tech_Delivered_Invoice |
| impulse | Billing_Details_Supervision_Sync | billing_details_supervision_sync_id |
| impulse | Billing_Details_Supervision_Sync | Case_ID |
| impulse | Billing_Details_Supervision_Sync | Received |
| impulse | Billing_Details_Supervision_Sync | Transfer_Complete |
| impulse | Billing_Details_Supervision_Sync | Transfer_Date |
| impulse | Billing_Details_Supervision_Sync | Transfer_Started |
| impulse | Cascade_Details | Cascade_Name |
| impulse | Cascade_Details | Case_ID |
| impulse | Cascade_Details | Protocol |
| impulse | Cascade_Details | Tech_Comments |
| impulse | Cascade_Details | TechForm_Version |
| impulse | Case_Charges | Case_Charges_ID |
| impulse | Case_Charges | Case_ID |
| impulse | Case_Charges | Contractual_Adj |
| impulse | Case_Charges | Local_Tax |
| impulse | Case_Charges | On_Site_Waiting |
| impulse | Case_Charges | Services |
| impulse | Case_Charges | State_Tax |
| impulse | Case_Charges | Supplies |
| impulse | Case_Charges | Time_Of_Charge |
| impulse | Case_Charges | Total_Before_Tax |
| impulse | Case_Charges | Total_Charged |
| impulse | Case_Charges | Total_Tax |
| impulse | Case_Complexity | case_complexity_id |
| impulse | Case_Complexity | case_id |
| impulse | Case_Complexity | certification_level_id |
| impulse | Case_Details | Case_Cancelled |
| impulse | Case_Details | Case_ID |
| impulse | Case_Details | Case_Uploaded |
| impulse | Case_Details | Hospital_ID |
| impulse | Case_Details | Infosys_Patient_ID |
| impulse | Case_Details | IP_Address |
| impulse | Case_Details | Professional_Report_Done |
| impulse | Case_Details | Room |
| impulse | Case_Details | Surgeon_ID |
| impulse | Case_Details | Type_of_Case |
| impulse | Case_Document | Case_Document_ID |
| impulse | Case_Document | Case_ID |
| impulse | Case_Document | CD_Document |
| impulse | Case_Document | CD_Document_Type |
| impulse | Case_Document | CD_External_Path |
| impulse | Case_Document | CD_Filename |
| impulse | Case_Employee | Billable_Minutes |
| impulse | Case_Employee | Case_ID |
| impulse | Case_Employee | Case_Role |
| impulse | Case_Employee | Employee_ID |
| impulse | Case_Employee | Non_billable_Minutes |
| impulse | Case_Employee | Start_Time |
| impulse | Case_Employee | Stop_Time |
| impulse | Case_Employee_Sync | Billable_Minutes |
| impulse | Case_Employee_Sync | case_employee_sync_id |
| impulse | Case_Employee_Sync | Case_ID |
| impulse | Case_Employee_Sync | Case_Role |
| impulse | Case_Employee_Sync | Date_Added |
| impulse | Case_Employee_Sync | Employee_ID |
| impulse | Case_Employee_Sync | New_Info |
| impulse | Case_Employee_Sync | Non_Billable_Minutes |
| impulse | Case_Employee_Sync | Transfer_Complete |
| impulse | Case_Employee_Sync | Transfer_Date |
| impulse | Case_Employee_Sync | Transfer_Started |
| impulse | Case_Instrumentation | Case_ID |
| impulse | Case_Instrumentation | Case_Instrumentation_ID |
| impulse | Case_Instrumentation | Spine_Instrumentation_1 |
| impulse | Case_Instrumentation | Spine_Instrumentation_2 |
| impulse | Case_Messages | Case_ID |
| impulse | Case_Messages | Case_Message_ID |
| impulse | Case_Messages | Case_Message_Status |
| impulse | Case_Messages | Case_Message_Type |
| impulse | Case_Modalities | Anal_Sphincter_EMG_CB |
| impulse | Case_Modalities | BCR_CB |
| impulse | Case_Modalities | Case_ID |
| impulse | Case_Modalities | Case_Modalities_ID |
| impulse | Case_Modalities | Cerebral_Ox_CB |
| impulse | Case_Modalities | CNAP_CB |
| impulse | Case_Modalities | Cortical_Mapping_CB |
| impulse | Case_Modalities | Cranial_EMG_CB |
| impulse | Case_Modalities | Direct_Nerve_EMG_CB |
| impulse | Case_Modalities | EEG_CB |
| impulse | Case_Modalities | Electrocochleography_CB |
| impulse | Case_Modalities | Electrocorticography_CB |
| impulse | Case_Modalities | EMG_0_Limb_CB |
| impulse | Case_Modalities | EMG_1_Limb_CB |
| impulse | Case_Modalities | EMG_2_Limb_CB |
| impulse | Case_Modalities | EMG_3_Limb_CB |
| impulse | Case_Modalities | EMG_4_Limb_CB |
| impulse | Case_Modalities | EOG_CB |
| impulse | Case_Modalities | ERG_CB |
| impulse | Case_Modalities | L_BAER_CB |
| impulse | Case_Modalities | L_Trunk_CB |
| impulse | Case_Modalities | L_VER_CB |
| impulse | Case_Modalities | Language_Test_CB |
| impulse | Case_Modalities | Larynx_EMG_CB |
| impulse | Case_Modalities | LL_SSEP_CB |
| impulse | Case_Modalities | LL_TCMEP_CB |
| impulse | Case_Modalities | LR_SSEP_CB |
| impulse | Case_Modalities | LR_TCMEP_CB |
| impulse | Case_Modalities | Non_Limb_EMG_CB |
| impulse | Case_Modalities | Occular_EMG_CB |
| impulse | Case_Modalities | Order_In_Chart_CB |
| impulse | Case_Modalities | Pedicle_Screw_CB |
| impulse | Case_Modalities | R_BAER_CB |
| impulse | Case_Modalities | R_Truck_CB |
| impulse | Case_Modalities | R_VER_CB |
| impulse | Case_Modalities | Surgeon_Signature_CB |
| impulse | Case_Modalities | TCD_CB |
| impulse | Case_Modalities | UL_SSEP_CB |
| impulse | Case_Modalities | UL_TCMEP_CB |
| impulse | Case_Modalities | UR_SSEP_CB |
| impulse | Case_Modalities | UR_TCMEP_CB |
| impulse | Case_Modalities | Verbal_Request_CB |
| impulse | Case_Muscles | Bilateral_Muscle |
| impulse | Case_Muscles | Case_ID |
| impulse | Case_Muscles | Case_Muscles_ID |
| impulse | Case_Muscles | Muscle_Name |
| impulse | Case_Muscles | Muscle_Type |
| impulse | Case_Nerves | Bilateral_Nerve |
| impulse | Case_Nerves | Case_ID |
| impulse | Case_Nerves | Case_Nerves_ID |
| impulse | Case_Nerves | EP_Modality |
| impulse | Case_Nerves | Nerve_Name |
| impulse | Case_Nerves | Number_Trials |
| impulse | Case_Nerves | Tech_Data_Quality |
| impulse | Case_Types | case_types_id |
| impulse | Case_Types | certification_level_id |
| impulse | Case_Types | type_of_case |
| impulse | Cerebral_Oximetry | Case_ID |
| impulse | Cerebral_Oximetry | Cerebral_Oximetry_ID |
| impulse | Cerebral_Oximetry | CO_Time |
| impulse | Cerebral_Oximetry | CO_Value |
| impulse | Cerebral_Oximetry | CO_Value_Type |
| impulse | Certification_Level | abbreviated_name |
| impulse | Certification_Level | certification_level_id |
| impulse | Certification_Level | course_level |
| impulse | Certification_Level | full_name |
| impulse | Certification_Level | prerequisite |
| impulse | Clinical_Finding | Case_ID |
| impulse | Clinical_Finding | Clinical_Finding_ID |
| impulse | Clinical_Finding | Clinical_Finding_Type |
| impulse | Clinical_Finding | Clinical_Statement |
| impulse | Clinical_Finding | Preop_Postop |
| impulse | Clinical_Finding | Side_Type |
| impulse | Clinical_Note | Case_ID |
| impulse | Clinical_Note | Post_op_Comment |
| impulse | Clinical_Note | Post_op_Deficit |
| impulse | Clinical_Note | Post_op_Status |
| impulse | Clinical_Note | Pre_op_Comment |
| impulse | CNAP | Case_ID |
| impulse | CNAP | CNAP_ID |
| impulse | CNAP | Nerve_Name |
| impulse | CNAP_Parameter | CNAP_ID |
| impulse | CNAP_Parameter | CNAP_Parameter |
| impulse | CNAP_Parameter | CNAP_Parameter_ID |
| impulse | CNAP_Parameter | CNAP_Parameter_Type |
| impulse | CNAP_Parameter | CNAP_Time |
| impulse | CNAP_Parameter | CNAP_Value_Type |
| impulse | CompanyHolidays | companyHolidaysID |
| impulse | CompanyHolidays | holidayDate |
| impulse | CompanyHolidays | holidayName |
| impulse | Corporate_Division | Corporate_Division_ID |
| impulse | Corporate_Division | Division_Active |
| impulse | Corporate_Division | Division_Code |
| impulse | Corporate_Division | Division_Name |
| impulse | Corporate_Division | Tax_ID_number |
| impulse | Corporate_Region | Clinical_Area |
| impulse | Corporate_Region | Corporate_Division_ID |
| impulse | Corporate_Region | Corporate_Region_ID |
| impulse | Corporate_Region | GP_Project_ID |
| impulse | Corporate_Region | Region_Active |
| impulse | Corporate_Region | Region_Name |
| impulse | Corporate_Region_Sync | Corporate_Region_ID |
| impulse | Corporate_Region_Sync | Corporate_Region_Sync_ID |
| impulse | Corporate_Region_Sync | Date_Added |
| impulse | Corporate_Region_Sync | Transfer_Complete |
| impulse | Corporate_Region_Sync | Transfer_Date |
| impulse | Corporate_Region_Sync | Transfer_Started |
| impulse | CPT_Claim | Case_ID |
| impulse | CPT_Claim | CPT_Claim_Code |
| impulse | CPT_Claim | CPT_Claim_Description |
| impulse | CPT_Claim | CPT_Claim_ID |
| impulse | CPT_Claim | CPT_Claim_Units |
| impulse | CPT_Prices | certification_level_id |
| impulse | CPT_Prices | cpt_code |
| impulse | CPT_Prices | cpt_description |
| impulse | CPT_Prices | cpt_prices_id |
| impulse | CPT_Prices | global_fee |
| impulse | CPT_Prices | global_va_fee |
| impulse | CPT_Prices | new_global_fee |
| impulse | CPT_Prices | new_pro_component_fee |
| impulse | CPT_Prices | old_global_fee |
| impulse | CPT_Prices | old_pro_fee |
| impulse | CPT_Prices | pro_component_fee |
| impulse | CPT_Prices | pro_va_fee |
| impulse | CPT_Prices | tech_component_fee |
| impulse | Employee | Alternate_First_name |
| impulse | Employee | Cell_Phone |
| impulse | Employee | Corporate_EMAIL |
| impulse | Employee | Direct_Phone |
| impulse | Employee | Display_Name |
| impulse | Employee | DOB |
| impulse | Employee | Employee_ID |
| impulse | Employee | First_name |
| impulse | Employee | GP_ID_Number |
| impulse | Employee | Hire_Date |
| impulse | Employee | Home_Fax_Number |
| impulse | Employee | Home_Phone |
| impulse | Employee | Initials |
| impulse | Employee | Last_Name |
| impulse | Employee | Location_Code |
| impulse | Employee | Middle_Name |
| impulse | Employee | Pager |
| impulse | Employee | Pager_Email |
| impulse | Employee | Personal_EMAIL |
| impulse | Employee | SSN |
| impulse | Employee | Suffix |
| impulse | Employee | Tech_ID_Number |
| impulse | Employee | Termination_Date |
| impulse | Employee | Title |
| impulse | Employee | Toll_Free_Pager |
| impulse | Employee_GP_Contact_Sync | Cell_Phone |
| impulse | Employee_GP_Contact_Sync | Employee_GP_Contact_Sync_ID |
| impulse | Employee_GP_Contact_Sync | GP_ID_Number |
| impulse | Employee_GP_Contact_Sync | Home_Phone |
| impulse | Employee_GP_Contact_Sync | Location_Code |
| impulse | Employee_GP_Contact_Sync | Office_Phone |
| impulse | Employee_GP_Contact_Sync | Pager |
| impulse | Employee_GP_Contact_Sync | Transfer_Complete |
| impulse | Employee_GP_Contact_Sync | Transfer_Date |
| impulse | Employee_GP_Contact_Sync | Transfer_Started |
| impulse | Employee_GP_Sync | Employee_GP_Sync_ID |
| impulse | Employee_GP_Sync | First_Name |
| impulse | Employee_GP_Sync | GP_ID_Number |
| impulse | Employee_GP_Sync | Hire_Date |
| impulse | Employee_GP_Sync | Last_Name |
| impulse | Employee_GP_Sync | Location_Code |
| impulse | Employee_GP_Sync | Received |
| impulse | Employee_GP_Sync | Tech_ID_Number |
| impulse | Employee_GP_Sync | Termination_Date |
| impulse | Employee_GP_Sync | Transfer_Complete |
| impulse | Employee_GP_Sync | Transfer_Date |
| impulse | Employee_GP_Sync | Transfer_Started |
| impulse | Employee_Sync | Employee_ID |
| impulse | Employee_Sync | Employee_Sync_ID |
| impulse | Employee_Sync | First_name |
| impulse | Employee_Sync | Last_name |
| impulse | Employee_Sync | Old_Tech_ID_Number |
| impulse | Employee_Sync | Sys_User |
| impulse | Employee_Sync | Tech_ID_Number |
| impulse | Employee_Sync | Transfer_Complete |
| impulse | Employee_Sync | Transfer_Date |
| impulse | Employee_Sync | Transfer_Started |
| impulse | Employee_Sync | Update_Date |
| impulse | EP_Message | EP_Left_Side |
| impulse | EP_Message | EP_Message_ID |
| impulse | EP_Message | EP_Message_Status |
| impulse | EP_Message | EP_Message_Type |
| impulse | EP_Message | Nerve_Parameter_ID |
| impulse | Error_Message | Case_ID |
| impulse | Error_Message | Error_Message_ID |
| impulse | Error_Message | Followup_Comments |
| impulse | Error_Message | Message |
| impulse | Error_Message | Message_Closed |
| impulse | Error_Message | Message_Type |
| impulse | Estimated_Revenue_Case | billing_category |
| impulse | Estimated_Revenue_Case | case_id |
| impulse | Estimated_Revenue_Case | estimated_revenue_case_id |
| impulse | Estimated_Revenue_Case | estimated_revenue_period_id |
| impulse | Estimated_Revenue_Case | hospital_name |
| impulse | Estimated_Revenue_Case | invoice_number |
| impulse | Estimated_Revenue_Case | monitored_online |
| impulse | Estimated_Revenue_Case | neurologist_involvement |
| impulse | Estimated_Revenue_Case | patient_name |
| impulse | Estimated_Revenue_Case | primary_payor |
| impulse | Estimated_Revenue_Case | primary_tech |
| impulse | Estimated_Revenue_Case | region_name |
| impulse | Estimated_Revenue_Case | service_date |
| impulse | Estimated_Revenue_Case | supervising_physician |
| impulse | Estimated_Revenue_Case | surgeon_name |
| impulse | Estimated_Revenue_Case | tech_hours |
| impulse | Estimated_Revenue_Case | va_hospital |
| impulse | Estimated_Revenue_Charge | charged_to |
| impulse | Estimated_Revenue_Charge | cpt_claim_description |
| impulse | Estimated_Revenue_Charge | cpt_claim_units |
| impulse | Estimated_Revenue_Charge | cpt_code |
| impulse | Estimated_Revenue_Charge | estimated_revenue_case_id |
| impulse | Estimated_Revenue_Charge | estimated_revenue_charge_id |
| impulse | Estimated_Revenue_Charge | fee_type |
| impulse | Estimated_Revenue_Charge | reimbursement_level |
| impulse | Estimated_Revenue_Charge | unit_charge |
| impulse | Estimated_Revenue_History | date_updated |
| impulse | Estimated_Revenue_History | ending_date |
| impulse | Estimated_Revenue_History | estimated_revenue_history_id |
| impulse | Estimated_Revenue_History | starting_date |
| impulse | Estimated_Revenue_History | update_action |
| impulse | Estimated_Revenue_History | user_comment |
| impulse | Estimated_Revenue_History | user_updated |
| impulse | Estimated_Revenue_Period | created_by |
| impulse | Estimated_Revenue_Period | creation_date |
| impulse | Estimated_Revenue_Period | end_date |
| impulse | Estimated_Revenue_Period | estimated_revenue_period_id |
| impulse | Estimated_Revenue_Period | start_date |
| impulse | Estimated_Revenue_Period | user_comment |
| impulse | Feedback_Messages | Feedback_Message |
| impulse | Feedback_Messages | Feedback_Messages_ID |
| impulse | Feedback_Messages | Feedback_Type |
| impulse | Feedback_Messages | Reader_Feedback_ID |
| impulse | Hospital | Charge_Sales_Tax |
| impulse | Hospital | Credentials_Required |
| impulse | Hospital | CRM_ID |
| impulse | Hospital | Hosp_Active |
| impulse | Hospital | Hosp_City |
| impulse | Hospital | Hosp_Country |
| impulse | Hospital | Hosp_Fax_Pro_Report |
| impulse | Hospital | Hosp_Phone |
| impulse | Hospital | Hosp_Postal_Code |
| impulse | Hospital | Hosp_State |
| impulse | Hospital | Hosp_Street |
| impulse | Hospital | Hospital_Callback |
| impulse | Hospital | Hospital_Code |
| impulse | Hospital | Hospital_Group_ID |
| impulse | Hospital | Hospital_ID |
| impulse | Hospital | Hospital_Name |
| impulse | Hospital | Invoice_Contract_Message |
| impulse | Hospital | NPI |
| impulse | Hospital | Online_Activation_Date |
| impulse | Hospital | Tech_Delivers_Invoice |
| impulse | Hospital | Tech_Invoice_Delivery_Inst |
| impulse | Hospital | Time_Zone_Adjustment |
| impulse | Hospital | VA_Hospital |
| impulse | Hospital_Group | Corporate_Region_ID |
| impulse | Hospital_Group | HG_Active |
| impulse | Hospital_Group | HG_City |
| impulse | Hospital_Group | HG_Country |
| impulse | Hospital_Group | HG_Fax |
| impulse | Hospital_Group | HG_Name |
| impulse | Hospital_Group | HG_Phone |
| impulse | Hospital_Group | HG_Postal_Code |
| impulse | Hospital_Group | HG_State |
| impulse | Hospital_Group | HG_Street |
| impulse | Hospital_Group | Hospital_Group_ID |
| impulse | Hospital_Group | Infosys_Group |
| impulse | Hospital_Surgeon_Link | CRM_ID |
| impulse | Hospital_Surgeon_Link | CRM_Link_Established |
| impulse | Hospital_Surgeon_Link | Hospital_ID |
| impulse | Hospital_Surgeon_Link | Hospital_Surgeon_Link_ID |
| impulse | Hospital_Surgeon_Link | Surgeon_ID |
| impulse | Insurance_Claim | Case_ID |
| impulse | Insurance_Claim | Insurance_Claim_ID |
| impulse | Insurance_Claim | Insurance_Company_Name |
| impulse | Insurance_Claim | Insurance_Group_Name |
| impulse | Insurance_Claim | Insurance_Group_Number |
| impulse | Insurance_Claim | Insurance_ID_Number |
| impulse | job_roles | displayOrder |
| impulse | job_roles | job_roles_id |
| impulse | job_roles | role |
| impulse | Local_Tax_Rate | City |
| impulse | Local_Tax_Rate | Ending_Date |
| impulse | Local_Tax_Rate | Local_Tax_Rate_ID |
| impulse | Local_Tax_Rate | Starting_Date |
| impulse | Local_Tax_Rate | Tax_Rate |
| impulse | Modality_Details | Case_ID |
| impulse | Modality_Details | Modality_Details_ID |
| impulse | Modality_Details | Modality_Info |
| impulse | Modality_Details | Modality_Name |
| impulse | Nerve_Parameter | Case_Nerves_ID |
| impulse | Nerve_Parameter | EP_Section_Type |
| impulse | Nerve_Parameter | EP_Trial_Type |
| impulse | Nerve_Parameter | Left_Amplitude_Value |
| impulse | Nerve_Parameter | Left_Latency_Value |
| impulse | Nerve_Parameter | Nerve_Parameter_ID |
| impulse | Nerve_Parameter | Right_Amplitude_Value |
| impulse | Nerve_Parameter | Right_Latency_Value |
| impulse | Patient | Case_ID |
| impulse | Patient | Hospital_Number |
| impulse | Patient | Patient_City |
| impulse | Patient | Patient_Country |
| impulse | Patient | Patient_DOB |
| impulse | Patient | Patient_email |
| impulse | Patient | patient_employment_status |
| impulse | Patient | Patient_Fax |
| impulse | Patient | Patient_First_name |
| impulse | Patient | Patient_Last_Name |
| impulse | Patient | patient_marital_status |
| impulse | Patient | patient_middle_initial |
| impulse | Patient | Patient_Name |
| impulse | Patient | Patient_Phone |
| impulse | Patient | Patient_Postal_Code |
| impulse | Patient | patient_sex |
| impulse | Patient | Patient_SSN |
| impulse | Patient | Patient_State |
| impulse | Patient | Patient_Street |
| impulse | Patient | Patient_Suffix |
| impulse | Patient | Patient_Title |
| impulse | Pedicle_Threshold | Case_ID |
| impulse | Pedicle_Threshold | Pedicle_ID |
| impulse | Pedicle_Threshold | Pedicle_Left_Value |
| impulse | Pedicle_Threshold | Pedicle_Level |
| impulse | Pedicle_Threshold | Pedicle_Right_Value |
| impulse | Pressure | Case_ID |
| impulse | Pressure | Pressure_ID |
| impulse | Pressure | Pressure_Time |
| impulse | Pressure | Pressure_Type |
| impulse | Pressure | Pressure_Value |
| impulse | Pressure | Value_Type |
| impulse | Process_Error_Log | correctionDate |
| impulse | Process_Error_Log | errorLevel |
| impulse | Process_Error_Log | errorMessage |
| impulse | Process_Error_Log | processDate |
| impulse | Process_Error_Log | processErrorLogID |
| impulse | Process_Error_Log | recordNumber |
| impulse | Process_Error_Log | transactionType |
| impulse | Reader | Employee_ID |
| impulse | Reader | Reader_ID |
| impulse | Reader | Report_Fax_Number |
| impulse | Reader | Report_Name |
| impulse | Reader_Feedback | Case_ID |
| impulse | Reader_Feedback | Feedback_Comment |
| impulse | Reader_Feedback | Reader_Feedback_ID |
| impulse | Reader_Report | Case_ID |
| impulse | Reader_Report | Data_Quality |
| impulse | Reader_Report | Reader_Report_ID |
| impulse | Reader_Report | Report_Message |
| impulse | Reader_Report | Report_Message_Type |
| impulse | Service_Contract | Auto_Renew |
| impulse | Service_Contract | Bill_Professional |
| impulse | Service_Contract | Bill_Supplies |
| impulse | Service_Contract | Bill_Technical |
| impulse | Service_Contract | Bill_Technical_Prompt |
| impulse | Service_Contract | Case_Bill_Rate |
| impulse | Service_Contract | Case_Max_Charge |
| impulse | Service_Contract | Case_Min_Charge |
| impulse | Service_Contract | Case_Rate |
| impulse | Service_Contract | Contract_Number |
| impulse | Service_Contract | Daily_Max_Charge |
| impulse | Service_Contract | Discounted_Case_Prompt |
| impulse | Service_Contract | Discounted_Case_Rate |
| impulse | Service_Contract | Discounted_Hour_Bill_rate |
| impulse | Service_Contract | Discounted_Hour_Prompt |
| impulse | Service_Contract | Hospital_Group_ID |
| impulse | Service_Contract | Hour_Bill_Hours_Rate_1 |
| impulse | Service_Contract | Hour_Bill_Rate |
| impulse | Service_Contract | Hour_Bill_Rate_2 |
| impulse | Service_Contract | Hour_Bill_Rate_No_Connection |
| impulse | Service_Contract | Hour_Tier1_Rate |
| impulse | Service_Contract | Hour_Tier2_Rate |
| impulse | Service_Contract | Hour_Tier3_Rate |
| impulse | Service_Contract | Hour_Wait_Rate |
| impulse | Service_Contract | Monthly_Min_Charge |
| impulse | Service_Contract | PO_Number |
| impulse | Service_Contract | Post_Tier_Hourly_Rate |
| impulse | Service_Contract | SC_End_Date |
| impulse | Service_Contract | SC_Start_Date |
| impulse | Service_Contract | Service_Contract_ID |
| impulse | Service_Contract | Surcharge_Case_Prompt |
| impulse | Service_Contract | Surcharge_Case_Rate |
| impulse | Service_Contract | Surcharge_Hour_Prompt |
| impulse | Service_Contract | Tier1_Stop_Hour |
| impulse | Service_Contract | Tier2_Stop_Hour |
| impulse | Service_Contract | Tier3_Stop_Hour |
| impulse | State_Tax_Rate | Ending_Date |
| impulse | State_Tax_Rate | Starting_Date |
| impulse | State_Tax_Rate | State_Code |
| impulse | State_Tax_Rate | State_Tax_Rate_ID |
| impulse | State_Tax_Rate | Tax_Rate |
| impulse | String_Map | Attribute_Name |
| impulse | String_Map | Attribute_Value |
| impulse | String_Map | Display_Order |
| impulse | String_Map | String_Map_ID |
| impulse | String_Map | Value |
| impulse | Supply_Claim | Case_ID |
| impulse | Supply_Claim | Charged_To |
| impulse | Supply_Claim | inventorySite |
| impulse | Supply_Claim | inventorySiteID |
| impulse | Supply_Claim | originalQuantity |
| impulse | Supply_Claim | Supply_Claim_ID |
| impulse | Supply_Claim | Supply_CPT_Code |
| impulse | Supply_Claim | Supply_Name |
| impulse | Supply_Claim | Supply_Price |
| impulse | Supply_Claim | Supply_Units |
| impulse | Supply_Claim_Sync | Case_ID |
| impulse | Supply_Claim_Sync | Charged_To |
| impulse | Supply_Claim_Sync | Date_Added |
| impulse | Supply_Claim_Sync | inventorySite |
| impulse | Supply_Claim_Sync | inventorySiteID |
| impulse | Supply_Claim_Sync | originalQuantity |
| impulse | Supply_Claim_Sync | supply_claim_sync_id |
| impulse | Supply_Claim_Sync | Supply_CPT_Code |
| impulse | Supply_Claim_Sync | Supply_Price |
| impulse | Supply_Claim_Sync | Supply_Units |
| impulse | Supply_Claim_Sync | Transfer_Complete |
| impulse | Supply_Claim_Sync | Transfer_Date |
| impulse | Supply_Claim_Sync | Transfer_Started |
| impulse | Supply_Prices | bill_in_pairs |
| impulse | Supply_Prices | cpt_code |
| impulse | Supply_Prices | end_Date |
| impulse | Supply_Prices | high_end_supply |
| impulse | Supply_Prices | procedure_Code |
| impulse | Supply_Prices | start_Date |
| impulse | Supply_Prices | supply_name |
| impulse | Supply_Prices | supply_price |
| impulse | Supply_Prices | supply_prices_id |
| impulse | Surgeon | CRM_ID |
| impulse | Surgeon | Infosys_ID |
| impulse | Surgeon | NPI |
| impulse | Surgeon | Primary_Region_ID |
| impulse | Surgeon | Secondary_Region_ID |
| impulse | Surgeon | Send_Pro_Report |
| impulse | Surgeon | Send_Pro_Report_By |
| impulse | Surgeon | Send_Pro_Report_By_ID |
| impulse | Surgeon | Surgeon_Active |
| impulse | Surgeon | Surgeon_Callback |
| impulse | Surgeon | Surgeon_Callback_Method |
| impulse | Surgeon | Surgeon_Callback_Method_ID |
| impulse | Surgeon | Surgeon_Cell_Phone |
| impulse | Surgeon | Surgeon_Contact |
| impulse | Surgeon | Surgeon_Direct_Phone |
| impulse | Surgeon | Surgeon_Email |
| impulse | Surgeon | Surgeon_fax_pro_report |
| impulse | Surgeon | Surgeon_ID |
| impulse | Surgeon | Surgeon_Info |
| impulse | Surgeon | Surgeon_Last_Name |
| impulse | Surgeon | Surgeon_Name |
| impulse | Surgeon | Surgeon_Pager |
| impulse | Surgeon | Surgeon_Personal_Email |
| impulse | Surgeon | Surgeon_Position |
| impulse | Surgeon | Surgeon_Specialty |
| impulse | Surgeon | Surgeon_Specialty_ID |
| impulse | Surgeon | Surgeon_Title |
| impulse | Surgeon | Surgeron_First_name |
| impulse | Surgeon | Surgical_Office_ID |
| impulse | Surgeon | UPIN |
| impulse | Surgical_Group | Active_Group |
| impulse | Surgical_Group | Surgical_Group_ID |
| impulse | Surgical_Group | Surgical_Group_Name |
| impulse | Surgical_Office | Professional_Report_Fax |
| impulse | Surgical_Office | Professional_Reporting |
| impulse | Surgical_Office | SO_City |
| impulse | Surgical_Office | SO_Country |
| impulse | Surgical_Office | SO_Postal_Code |
| impulse | Surgical_Office | SO_State |
| impulse | Surgical_Office | SO_Street |
| impulse | Surgical_Office | Surgical_Group_ID |
| impulse | Surgical_Office | Surgical_Office_ID |
| impulse | TCeMEP | Case_ID |
| impulse | TCeMEP | TCeMEP_ID |
| impulse | TCeMEP | Time_of_Reading |
| impulse | TCeMEP_Parameter | TCeMEP_ID |
| impulse | TCeMEP_Parameter | TCeMEP_Parameter_ID |
| impulse | TCeMEP_Parameter | TCeMEP_Section_Type |
| impulse | TCeMEP_Parameter | TCeMep_Side |
| impulse | TCeMEP_Parameter | TCeMEP_Value |
| impulse | TEMG_DirectNerve | Case_ID |
| impulse | TEMG_DirectNerve | TEMG_DirectNerve_ID |
| impulse | TEMG_DirectNerve | TEMG_Left_Value |
| impulse | TEMG_DirectNerve | TEMG_Nerve |
| impulse | TEMG_DirectNerve | TEMG_Right_Value |
| impulse | Temperature | Case_ID |
| impulse | Temperature | Temperature_ID |
| impulse | Temperature | Temperature_Time |
| impulse | Temperature | Temperature_Type |
| impulse | Temperature | Temperature_Value |
| impulse | Temperature | Temperature_Value_Type |
| impulse | Time_Claim | Billable_Hours |
| impulse | Time_Claim | Case_ID |
| impulse | Time_Claim | Claim_Start_Time |
| impulse | Time_Claim | Claim_Stop_Time |
| impulse | Time_Claim | Time_Claim_ID |
| impulse | Time_Claim | Type_of_Time_Claim |
| impulse | Time_Claim_Sync | Billable_Hours |
| impulse | Time_Claim_Sync | Case_ID |
| impulse | Time_Claim_Sync | Date_Added |
| impulse | Time_Claim_Sync | New_Info |
| impulse | Time_Claim_Sync | time_claim_sync_id |
| impulse | Time_Claim_Sync | Transfer_Complete |
| impulse | Time_Claim_Sync | Transfer_Date |
| impulse | Time_Claim_Sync | Transfer_Started |
| impulse | Time_Claim_Sync | Type_of_Time_Claim |
| impulse | Time_Stamp | Action_Performed |
| impulse | Time_Stamp | Case_ID |
| impulse | Time_Stamp | Date_Stamped |
| impulse | Time_Stamp | Performed_By |
| impulse | Time_Stamp | Time_Stamp_ID |
| impulse | TOF | Case_ID |
| impulse | TOF | TOF_ID |
| impulse | TOF | TOF_Time |
| impulse | TOF | TOF_Value |
| impulse | TOF | TOF_Value_Type |
| impulse | Unbilled_AR | billing_category |
| impulse | Unbilled_AR | case_id |
| impulse | Unbilled_AR | fee_type |
| impulse | Unbilled_AR | neurologist_id |
| impulse | Unbilled_AR | primary_payor |
| impulse | Unbilled_AR | total_sent_to_gp |
| impulse | Unbilled_AR | unbilled_ar_id |
| impulse | Unbilled_AR_Charge | case_id |
| impulse | Unbilled_AR_Charge | charge_code |
| impulse | Unbilled_AR_Charge | unbilled_ar_charge_id |
| impulse | Unbilled_AR_Charge | unbilled_ar_id |
| impulse | Unbilled_AR_Charge | unit_charge |
| impulse | Unbilled_AR_Charge | units |
| impulse | Unbilled_AR_Sync | Case_ID |
| impulse | Unbilled_AR_Sync | Date_Added |
| impulse | Unbilled_AR_Sync | infosysChargesID |
| impulse | Unbilled_AR_Sync | locationCode |
| impulse | Unbilled_AR_Sync | Transfer_Complete |
| impulse | Unbilled_AR_Sync | Transfer_Date |
| impulse | Unbilled_AR_Sync | Transfer_Started |
| impulse | Unbilled_AR_Sync | unbilled_ar_id |
| impulse | Unbilled_AR_Sync | unbilled_ar_sync_id |
| impulse | unbilledCasesWork | billing_category |
| impulse | unbilledCasesWork | case_id |
| impulse | unbilledCasesWork | fee_type |
| impulse | unbilledCasesWork | primaryInsurance |
| impulse | unbilledCasesWork | secondaryInsurance |
| impulse | unbilledCasesWork | Transfer_Complete |
| impulse | unbilledCasesWork | Transfer_Date |
| impulse | unbilledCasesWork | Transfer_Started |
| scheduler | AccessControl | Access_Control_ID |
| scheduler | AccessControl | Access_Mode_ID |
| scheduler | AccessControl | Corporate_Region_ID |
| scheduler | AccessControl | User_Access_ID |
| scheduler | AccessDefinition | AccessDefinitionID |
| scheduler | AccessDefinition | AccessModeID |
| scheduler | AccessDefinition | ScheduleActionsID |
| scheduler | AccessMode | AccessMode |
| scheduler | AccessMode | AccessModeID |
| scheduler | AccessMode | DisplayOrder |
| scheduler | Active_Cases | ActiveCasesID |
| scheduler | Active_Cases | assistanceRequestActive |
| scheduler | Active_Cases | assistanceRequestCancelled |
| scheduler | Active_Cases | assistanceRequested |
| scheduler | Active_Cases | birthdate |
| scheduler | Active_Cases | caseAppended |
| scheduler | Active_Cases | caseComplete |
| scheduler | Active_Cases | caseID |
| scheduler | Active_Cases | caseRestarted |
| scheduler | Active_Cases | caseRunning |
| scheduler | Active_Cases | caseStarted |
| scheduler | Active_Cases | caseTimeout |
| scheduler | Active_Cases | diagnosis |
| scheduler | Active_Cases | estMonitorEnd |
| scheduler | Active_Cases | estMonitorStart |
| scheduler | Active_Cases | firstEvent |
| scheduler | Active_Cases | lastEvent |
| scheduler | Active_Cases | machine |
| scheduler | Active_Cases | orRoom |
| scheduler | Active_Cases | patientFirstName |
| scheduler | Active_Cases | patientID |
| scheduler | Active_Cases | patientLastName |
| scheduler | Active_Cases | readyForHistory |
| scheduler | Active_Cases | scheduleID |
| scheduler | Active_Cases | smdAccessed |
| scheduler | Active_Cases | smdCreated |
| scheduler | Active_Cases | smdFile |
| scheduler | Active_Cases | smdModified |
| scheduler | Active_Cases | surgeon |
| scheduler | Active_Cases | surgicalProcedure |
| scheduler | Active_Cases | technologist |
| scheduler | Active_Cases | user |
| scheduler | Active_Cases_History | ActiveCasesHistoryID |
| scheduler | Active_Cases_History | ActiveCasesID |
| scheduler | Active_Cases_History | birthdate |
| scheduler | Active_Cases_History | caseAppended |
| scheduler | Active_Cases_History | caseComplete |
| scheduler | Active_Cases_History | caseID |
| scheduler | Active_Cases_History | caseRestarted |
| scheduler | Active_Cases_History | caseRunning |
| scheduler | Active_Cases_History | caseStarted |
| scheduler | Active_Cases_History | caseTimeout |
| scheduler | Active_Cases_History | diagnosis |
| scheduler | Active_Cases_History | estMonitorEnd |
| scheduler | Active_Cases_History | estMonitorStart |
| scheduler | Active_Cases_History | firstEvent |
| scheduler | Active_Cases_History | lastEvent |
| scheduler | Active_Cases_History | machine |
| scheduler | Active_Cases_History | movedToHistory |
| scheduler | Active_Cases_History | orRoom |
| scheduler | Active_Cases_History | patientFirstName |
| scheduler | Active_Cases_History | patientID |
| scheduler | Active_Cases_History | patientLastName |
| scheduler | Active_Cases_History | scheduleID |
| scheduler | Active_Cases_History | smdAccessed |
| scheduler | Active_Cases_History | smdCreated |
| scheduler | Active_Cases_History | smdFile |
| scheduler | Active_Cases_History | smdModified |
| scheduler | Active_Cases_History | surgeon |
| scheduler | Active_Cases_History | surgicalProcedure |
| scheduler | Active_Cases_History | technologist |
| scheduler | Active_Cases_History | user |
| scheduler | Callback | Callback_Date |
| scheduler | Callback | Callback_ID |
| scheduler | Callback | Callback_Notes |
| scheduler | Callback | Schedule_ID |
| scheduler | Callback | Spoke_With |
| scheduler | Callback | Username |
| scheduler | Cancel_Reasons | Cancel_Reason |
| scheduler | Cancel_Reasons | Cancel_Reasons_ID |
| scheduler | Cancel_Reasons | Display_Order |
| scheduler | Case_Note | Added_By |
| scheduler | Case_Note | Case_Note_ID |
| scheduler | Case_Note | CaseID |
| scheduler | Case_Note | Date_Added |
| scheduler | Case_Note | Note |
| scheduler | Case_Note | ScheduleID |
| scheduler | Case_Rejection_Reasons | Case_Rejection_Category |
| scheduler | Case_Rejection_Reasons | Case_Rejection_Reason |
| scheduler | Case_Rejection_Reasons | Case_Rejection_Reasons_ID |
| scheduler | Case_Rejection_Reasons | Display_Order |
| scheduler | Case_Rejection_Reasons | Visible |
| scheduler | Case_Reporter_Debug_Log | action |
| scheduler | Case_Reporter_Debug_Log | action_date |
| scheduler | Case_Reporter_Debug_Log | case_reporter_debug_log_id |
| scheduler | Case_Reporter_Debug_Log | message |
| scheduler | Case_Reporter_Debug_Log | username |
| scheduler | Case_Tracker | Approved_Version |
| scheduler | Case_Tracker | Case_Tracker_ID |
| scheduler | Case_Tracker | Cutoff_Date |
| scheduler | Case_Transfer_Reasons | Case_Transfer_Category |
| scheduler | Case_Transfer_Reasons | Case_Transfer_Reason |
| scheduler | Case_Transfer_Reasons | Case_Transfer_Reasons_ID |
| scheduler | Case_Transfer_Reasons | Display_Order |
| scheduler | Case_Transfer_Reasons | Visible |
| scheduler | Case_Types | Case_Types_ID |
| scheduler | Case_Types | Display_Order |
| scheduler | Case_Types | Type_Of_Case |
| scheduler | Client_Confirmation | Client_Name |
| scheduler | Client_Confirmation | Confirmed |
| scheduler | Client_Confirmation | ScheduleID |
| scheduler | Dashboard_Notes | CaseID |
| scheduler | Dashboard_Notes | Note |
| scheduler | Dashboard_Notes | ScheduleID |
| scheduler | Employee | Employee_ID |
| scheduler | Employee | IsNeurologist |
| scheduler | Employee | IsTech |
| scheduler | Employee | ReviewAllCases |
| scheduler | Employee | SeeAllRegions |
| scheduler | Employee_Hospital | Employee_Credentialed |
| scheduler | Employee_Hospital | Employee_ID |
| scheduler | Employee_Hospital | Ending_Date |
| scheduler | Employee_Hospital | Exclude_Employee |
| scheduler | Employee_Hospital | Hospital_ID |
| scheduler | Employee_Hospital | Starting_Date |
| scheduler | Employee_Hospital_Sync | active |
| scheduler | Employee_Hospital_Sync | employee_hospital_sync_id |
| scheduler | Employee_Hospital_Sync | employID |
| scheduler | Employee_Hospital_Sync | endDate |
| scheduler | Employee_Hospital_Sync | newHospital |
| scheduler | Employee_Hospital_Sync | newStaffCred |
| scheduler | Employee_Hospital_Sync | oldHospital |
| scheduler | Employee_Hospital_Sync | oldStaffCred |
| scheduler | Employee_Hospital_Sync | Received |
| scheduler | Employee_Hospital_Sync | startDate |
| scheduler | Employee_Hospital_Sync | Transfer_Complete |
| scheduler | Employee_Hospital_Sync | Transfer_Date |
| scheduler | Employee_Hospital_Sync | Transfer_Started |
| scheduler | Employee_Path | Employee_ID |
| scheduler | Employee_Path | Employee_Path_ID |
| scheduler | Employee_Path | Path |
| scheduler | Event_Messages_History | AddedBy |
| scheduler | Event_Messages_History | CaseID |
| scheduler | Event_Messages_History | DateAdded |
| scheduler | Event_Messages_History | EventMessagesHistoryID |
| scheduler | Event_Messages_History | EventMessagesID |
| scheduler | Event_Messages_History | Machine |
| scheduler | Event_Messages_History | Message |
| scheduler | Event_Messages_History | MessageTime |
| scheduler | Event_Messages_History | MessageType |
| scheduler | Event_Messages_History | movedToHistory |
| scheduler | Event_Messages_History | Transfer_Complete |
| scheduler | Event_Messages_History | Transfer_Date |
| scheduler | Event_Messages_History | Transfer_Started |
| scheduler | EventMessages | AddedBy |
| scheduler | EventMessages | CaseID |
| scheduler | EventMessages | DateAdded |
| scheduler | EventMessages | EventMessagesID |
| scheduler | EventMessages | Machine |
| scheduler | EventMessages | Message |
| scheduler | EventMessages | MessageTime |
| scheduler | EventMessages | MessageType |
| scheduler | EventMessages | readyForHistory |
| scheduler | EventMessages | Transfer_Complete |
| scheduler | EventMessages | Transfer_Date |
| scheduler | EventMessages | Transfer_Started |
| scheduler | Fax_Log | Date_Transmitted |
| scheduler | Fax_Log | Fax_Log_ID |
| scheduler | Fax_Log | Fax_Number |
| scheduler | Fax_Log | ScheduleID |
| scheduler | Hospital_Access | Hospital_Access_ID |
| scheduler | Hospital_Access | Hospital_ID |
| scheduler | Hospital_Access | User_Access_ID |
| scheduler | Hospital_Coordinator | emailNotification |
| scheduler | Hospital_Coordinator | Employee_ID |
| scheduler | Hospital_Coordinator | Hospital_ID |
| scheduler | Hospital_Coordinator | pagerNotification |
| scheduler | Machines | Case_Tracker_Version |
| scheduler | Machines | Machine_Name |
| scheduler | Machines | Machines_ID |
| scheduler | Machines | Techform_Version |
| scheduler | Message | Days_Before_Repeat |
| scheduler | Message | Message_Added |
| scheduler | Message | Message_Added_By |
| scheduler | Message | Message_EndDate |
| scheduler | Message | Message_ID |
| scheduler | Message | Message_Removed |
| scheduler | Message | Message_Removed_By |
| scheduler | Message | Message_Repeats |
| scheduler | Message | Message_StartDate |
| scheduler | Message | Show_Message |
| scheduler | New_Surgeons | Hospital_ID |
| scheduler | New_Surgeons | New_Surgeons_ID |
| scheduler | New_Surgeons | NS_Add_Date |
| scheduler | New_Surgeons | NS_Added_By |
| scheduler | New_Surgeons | NS_Has_Case_Data |
| scheduler | New_Surgeons | Surgeon_ID |
| scheduler | Oncall_Action_Log | Action_Date |
| scheduler | Oncall_Action_Log | Action_Requested |
| scheduler | Oncall_Action_Log | Category |
| scheduler | Oncall_Action_Log | Explanation |
| scheduler | Oncall_Action_Log | Info_Source |
| scheduler | Oncall_Action_Log | Oncall_Action_Log_ID |
| scheduler | Oncall_Action_Log | Oncall_Schedule_ID |
| scheduler | Oncall_Action_Log | Username |
| scheduler | Oncall_Region | Corporate_Region_ID |
| scheduler | Oncall_Region | Oncall_Levels |
| scheduler | Oncall_Region | Oncall_Region_Active |
| scheduler | Oncall_Region | Oncall_Region_ID |
| scheduler | Oncall_Region | Oncall_Region_Name |
| scheduler | Oncall_Region_Hospital | Hospital_ID |
| scheduler | Oncall_Region_Hospital | Oncall_Region_ID |
| scheduler | Oncall_Schedule | Ending_Date |
| scheduler | Oncall_Schedule | Oncall_Region_ID |
| scheduler | Oncall_Schedule | Oncall_Schedule_ID |
| scheduler | Oncall_Schedule | Starting_Date |
| scheduler | Oncall_Schedule_Employee | Employee_ID |
| scheduler | Oncall_Schedule_Employee | Oncall_Schedule_Employee_ID |
| scheduler | Oncall_Schedule_Employee | Oncall_Schedule_ID |
| scheduler | Oncall_Schedule_Employee | Priority |
| scheduler | Oncall_State | Oncall_State |
| scheduler | Oncall_State | Oncall_State_Active |
| scheduler | Oncall_State | Oncall_State_ID |
| scheduler | Physician_Oncall_Changes | Date_Updated |
| scheduler | Physician_Oncall_Changes | Employee_ID |
| scheduler | Physician_Oncall_Changes | Ending_Date |
| scheduler | Physician_Oncall_Changes | Oncall_State |
| scheduler | Physician_Oncall_Changes | Physician_Oncall_Changes_ID |
| scheduler | Physician_Oncall_Changes | Starting_Date |
| scheduler | Physician_Oncall_Changes | Update_Action |
| scheduler | Physician_Oncall_Changes | Updated_By |
| scheduler | Physician_Oncall_Schedule | Ending_Date |
| scheduler | Physician_Oncall_Schedule | Oncall_State |
| scheduler | Physician_Oncall_Schedule | Physician_Oncall_Schedule_ID |
| scheduler | Physician_Oncall_Schedule | Starting_Date |
| scheduler | Physician_Oncall_Schedule_Employee | Active |
| scheduler | Physician_Oncall_Schedule_Employee | Employee_ID |
| scheduler | Physician_Oncall_Schedule_Employee | Physician_Oncall_Schedule_Employee_ID |
| scheduler | Physician_Oncall_Schedule_Employee | Physician_Oncall_Schedule_ID |
| scheduler | Physician_Oncall_Schedule_Employee | Priority |
| scheduler | Post_Upload_Action_Log | Action_Date |
| scheduler | Post_Upload_Action_Log | Action_Requested |
| scheduler | Post_Upload_Action_Log | Category |
| scheduler | Post_Upload_Action_Log | Explanation |
| scheduler | Post_Upload_Action_Log | Info_Source |
| scheduler | Post_Upload_Action_Log | PostUpload_Action_Log_ID |
| scheduler | Post_Upload_Action_Log | ScheduleID |
| scheduler | Post_Upload_Action_Log | Username |
| scheduler | Print_Log | Copies_Printed |
| scheduler | Print_Log | Date_Printed |
| scheduler | Print_Log | Print_Log_ID |
| scheduler | Print_Log | Printer_Name |
| scheduler | Print_Log | Report_Name |
| scheduler | Print_Log | ScheduleID |
| scheduler | Process_Error_Log | correctionDate |
| scheduler | Process_Error_Log | errorLevel |
| scheduler | Process_Error_Log | errorMessage |
| scheduler | Process_Error_Log | processDate |
| scheduler | Process_Error_Log | processErrorLogID |
| scheduler | Process_Error_Log | transactionType |
| scheduler | Reconciliation_Details | hospital_id |
| scheduler | Reconciliation_Details | primary_tech_id |
| scheduler | Reconciliation_Details | rec_callbackRequired |
| scheduler | Reconciliation_Details | rec_case_status |
| scheduler | Reconciliation_Details | rec_date_of_surgery |
| scheduler | Reconciliation_Details | rec_diagnosis |
| scheduler | Reconciliation_Details | rec_end_of_surgery |
| scheduler | Reconciliation_Details | rec_instructions |
| scheduler | Reconciliation_Details | rec_notificationSent |
| scheduler | Reconciliation_Details | rec_original_date_of_surgery |
| scheduler | Reconciliation_Details | rec_other_services |
| scheduler | Reconciliation_Details | rec_patient_DOB |
| scheduler | Reconciliation_Details | rec_patient_name |
| scheduler | Reconciliation_Details | rec_surgical_procedure |
| scheduler | Reconciliation_Details | rec_type_of_surgery |
| scheduler | Reconciliation_Details | reconciliation_details_id |
| scheduler | Reconciliation_Details | scheduleID |
| scheduler | Reconciliation_Details | surgeon_id |
| scheduler | Reconciliation_Employee | assigned_by |
| scheduler | Reconciliation_Employee | assigned_role |
| scheduler | Reconciliation_Employee | confirmed |
| scheduler | Reconciliation_Employee | employee_id |
| scheduler | Reconciliation_Employee | end_dateTime |
| scheduler | Reconciliation_Employee | notified |
| scheduler | Reconciliation_Employee | reconciliation_details_id |
| scheduler | Reconciliation_Employee | reconciliation_employee_id |
| scheduler | Reconciliation_Employee | start_dateTime |
| scheduler | Region_Coordinator | emailNotification |
| scheduler | Region_Coordinator | Employee_ID |
| scheduler | Region_Coordinator | pagerNotification |
| scheduler | Region_Coordinator | Region_ID |
| scheduler | Region_Tech | backup_region |
| scheduler | Region_Tech | Employee_ID |
| scheduler | Region_Tech | exclude_region |
| scheduler | Region_Tech | primary_region |
| scheduler | Region_Tech | Region_ID |
| scheduler | Region_Tech | tertiary_region |
| scheduler | RegionalCoverageTypes | coverageID |
| scheduler | RegionalCoverageTypes | coverageType |
| scheduler | RegionalCoverageTypes | displayOrder |
| scheduler | RegionalCoverageTypes | regionalCoverageTypeID |
| scheduler | Remote_Cases | birthdate |
| scheduler | Remote_Cases | caseID |
| scheduler | Remote_Cases | diagnosis |
| scheduler | Remote_Cases | firstEvent |
| scheduler | Remote_Cases | lastEvent |
| scheduler | Remote_Cases | machine |
| scheduler | Remote_Cases | orRoom |
| scheduler | Remote_Cases | patientFirstName |
| scheduler | Remote_Cases | patientID |
| scheduler | Remote_Cases | patientLastName |
| scheduler | Remote_Cases | readyForHistory |
| scheduler | Remote_Cases | RemoteCasesID |
| scheduler | Remote_Cases | remoteComplete |
| scheduler | Remote_Cases | remoteMachine |
| scheduler | Remote_Cases | remoteRunning |
| scheduler | Remote_Cases | remoteStarted |
| scheduler | Remote_Cases | remoteTimeout |
| scheduler | Remote_Cases | scheduleID |
| scheduler | Remote_Cases | smdFile |
| scheduler | Remote_Cases | surgeon |
| scheduler | Remote_Cases | surgicalProcedure |
| scheduler | Remote_Cases | technologist |
| scheduler | Remote_Cases | user |
| scheduler | Remote_Cases_History | birthdate |
| scheduler | Remote_Cases_History | caseID |
| scheduler | Remote_Cases_History | diagnosis |
| scheduler | Remote_Cases_History | firstEvent |
| scheduler | Remote_Cases_History | lastEvent |
| scheduler | Remote_Cases_History | machine |
| scheduler | Remote_Cases_History | movedToHistory |
| scheduler | Remote_Cases_History | orRoom |
| scheduler | Remote_Cases_History | patientFirstName |
| scheduler | Remote_Cases_History | patientID |
| scheduler | Remote_Cases_History | patientLastName |
| scheduler | Remote_Cases_History | RemoteCasesHistoryID |
| scheduler | Remote_Cases_History | RemoteCasesID |
| scheduler | Remote_Cases_History | remoteComplete |
| scheduler | Remote_Cases_History | remoteMachine |
| scheduler | Remote_Cases_History | remoteRunning |
| scheduler | Remote_Cases_History | remoteStarted |
| scheduler | Remote_Cases_History | remoteTimeout |
| scheduler | Remote_Cases_History | scheduleID |
| scheduler | Remote_Cases_History | smdFile |
| scheduler | Remote_Cases_History | surgeon |
| scheduler | Remote_Cases_History | surgicalProcedure |
| scheduler | Remote_Cases_History | technologist |
| scheduler | Remote_Cases_History | user |
| scheduler | Requested_Action | Action_Date |
| scheduler | Requested_Action | Action_Requested |
| scheduler | Requested_Action | Category |
| scheduler | Requested_Action | Explanation |
| scheduler | Requested_Action | Info_Source |
| scheduler | Requested_Action | Schedule_Action_ID |
| scheduler | Requested_Action | ScheduleID |
| scheduler | Requested_Action | Username |
| scheduler | Requested_Service | Requested_Service_ID |
| scheduler | Requested_Service | ScheduleID |
| scheduler | Requested_Service | ServiceID |
| scheduler | Roles | Display_Order |
| scheduler | Roles | Role_Name |
| scheduler | Roles | Roles_ID |
| scheduler | Schedule | CallbackRequired |
| scheduler | Schedule | Case_ID |
| scheduler | Schedule | Case_Number |
| scheduler | Schedule | Case_Status |
| scheduler | Schedule | Hospital_ID |
| scheduler | Schedule | Length_Of_Surgery |
| scheduler | Schedule | NotificationSent |
| scheduler | Schedule | Sch_Date_of_Surgery |
| scheduler | Schedule | Sch_Diagnosis |
| scheduler | Schedule | Sch_End_of_Surgery |
| scheduler | Schedule | Sch_Instructions |
| scheduler | Schedule | sch_original_date_of_surgery |
| scheduler | Schedule | Sch_Other_Services |
| scheduler | Schedule | Sch_Patient_DOB |
| scheduler | Schedule | Sch_Patient_Name |
| scheduler | Schedule | Sch_Surgical_Procedure |
| scheduler | Schedule | Sch_Type_of_Surgery |
| scheduler | Schedule | ScheduleID |
| scheduler | Schedule | Surgeon_ID |
| scheduler | Schedule | Surgery_End |
| scheduler | Schedule | training_opportunity |
| scheduler | Schedule_Employee | Assigned_By |
| scheduler | Schedule_Employee | Assigned_Role |
| scheduler | Schedule_Employee | Confirmed |
| scheduler | Schedule_Employee | Employee_ID |
| scheduler | Schedule_Employee | End_DateTime |
| scheduler | Schedule_Employee | Notified |
| scheduler | Schedule_Employee | ScheduleID |
| scheduler | Schedule_Employee | Start_DateTime |
| scheduler | Schedule_Physician_Comments | Employee_ID |
| scheduler | Schedule_Physician_Comments | Message |
| scheduler | Schedule_Physician_Comments | Message_Date |
| scheduler | Schedule_Physician_Comments | Schedule_Physician_Comments_ID |
| scheduler | Schedule_Physician_Comments | ScheduleID |
| scheduler | ScheduleActions | customerView |
| scheduler | ScheduleActions | scheduleAction |
| scheduler | ScheduleActions | scheduleActionsID |
| scheduler | Scheduled_Time_Off | Away_Date |
| scheduler | Scheduled_Time_Off | Cancelled_By |
| scheduler | Scheduled_Time_Off | Comments |
| scheduler | Scheduled_Time_Off | Date_Cancelled |
| scheduler | Scheduled_Time_Off | Date_Requested |
| scheduler | Scheduled_Time_Off | Employee_ID |
| scheduler | Scheduled_Time_Off | Reason_Not_Available |
| scheduler | Scheduled_Time_Off | Requested_By |
| scheduler | Scheduled_Time_Off | Return_Date |
| scheduler | Scheduled_Time_Off | Scheduled_Time_Off_ID |
| scheduler | Services | Abbreviated_Service_Name |
| scheduler | Services | Display_Order |
| scheduler | Services | Electrode_Message |
| scheduler | Services | Service_Name |
| scheduler | Services | Services_ID |
| scheduler | Single_Message | Message_ID |
| scheduler | Single_Message | Single_Message_Date |
| scheduler | Single_Message | Single_Message_ID |
| scheduler | Single_Message | Single_Message_Removed |
| scheduler | Single_Message | Single_Message_Removed_By |
| scheduler | State_Licenses | Employee_ID |
| scheduler | State_Licenses | endDate |
| scheduler | State_Licenses | licensed |
| scheduler | State_Licenses | startDate |
| scheduler | State_Licenses | State |
| scheduler | State_Licenses_Sync | employID |
| scheduler | State_Licenses_Sync | endDate |
| scheduler | State_Licenses_Sync | licensed |
| scheduler | State_Licenses_Sync | newState |
| scheduler | State_Licenses_Sync | oldState |
| scheduler | State_Licenses_Sync | Received |
| scheduler | State_Licenses_Sync | startDate |
| scheduler | State_Licenses_Sync | state_licenses_sync_id |
| scheduler | State_Licenses_Sync | Transfer_Complete |
| scheduler | State_Licenses_Sync | Transfer_Date |
| scheduler | State_Licenses_Sync | Transfer_Started |
| scheduler | Status_Filters | Display_Order |
| scheduler | Status_Filters | Filter_Name |
| scheduler | Status_Filters | Status_Filters_ID |
| scheduler | Surgeon_Access | Surgeon_Access_ID |
| scheduler | Surgeon_Access | Surgeon_ID |
| scheduler | Surgeon_Access | User_Access_ID |
| scheduler | Techform | Approved_Version |
| scheduler | Techform | Cutoff_Date |
| scheduler | Techform | Techform_ID |
| scheduler | Time_Off_Reasons | Display_Order |
| scheduler | Time_Off_Reasons | Time_Off_Reason |
| scheduler | Time_Off_Reasons | Time_Off_Reasons_ID |
| scheduler | Upload_Details | Billing_Prep_Complete |
| scheduler | Upload_Details | Billing_Prep_Started |
| scheduler | Upload_Details | Case_Rejected |
| scheduler | Upload_Details | Case_Rejected_Minutes |
| scheduler | Upload_Details | Case_Reviewed |
| scheduler | Upload_Details | Invoice_Delivered |
| scheduler | Upload_Details | Invoice_Number |
| scheduler | Upload_Details | Modality_Error_On_Upload |
| scheduler | Upload_Details | Monitoring_Neurologist_ID |
| scheduler | Upload_Details | Neurologist_Involvement |
| scheduler | Upload_Details | Patient_Event |
| scheduler | Upload_Details | patient_name |
| scheduler | Upload_Details | Primary_Tech_ID |
| scheduler | Upload_Details | Relief_Neurologist_ID |
| scheduler | Upload_Details | Relief_Tech_ID |
| scheduler | Upload_Details | Report_Faxed |
| scheduler | Upload_Details | Report_Path |
| scheduler | Upload_Details | Report_Printed |
| scheduler | Upload_Details | Report_Requested_ASAP |
| scheduler | Upload_Details | Report_Submitted |
| scheduler | Upload_Details | Reporting_Neurologist_ID |
| scheduler | Upload_Details | ScheduleID |
| scheduler | Upload_Details | Service_Date |
| scheduler | Upload_Details | Techform_Version |
| scheduler | Upload_Details | Upload_Attempts |
| scheduler | Upload_Details | Upload_Complete |
| scheduler | Upload_Details | Upload_Details_ID |
| scheduler | Upload_Details | Upload_Machine |
| scheduler | Upload_Details | Upload_Path |
| scheduler | Upload_Details | Upload_Restarted |
| scheduler | Upload_Details | Upload_Size |
| scheduler | Upload_Details | Upload_Started |
| scheduler | Upload_Details | username |
| scheduler | Upload_Details_Completed_Reports_Sync | GP_ID_Number |
| scheduler | Upload_Details_Completed_Reports_Sync | Infosys_Patient_ID |
| scheduler | Upload_Details_Completed_Reports_Sync | Received |
| scheduler | Upload_Details_Completed_Reports_Sync | ScheduleID |
| scheduler | Upload_Details_Completed_Reports_Sync | Transfer_Complete |
| scheduler | Upload_Details_Completed_Reports_Sync | Transfer_Date |
| scheduler | Upload_Details_Completed_Reports_Sync | Transfer_Started |
| scheduler | Upload_Details_Completed_Reports_Sync | upload_details_completed_reports_sync_id |
| scheduler | Upload_Rejections | Employee_ID |
| scheduler | Upload_Rejections | Message |
| scheduler | Upload_Rejections | Reason |
| scheduler | Upload_Rejections | Rejected |
| scheduler | Upload_Rejections | Rejection_Date |
| scheduler | Upload_Rejections | ScheduleID |
| scheduler | Upload_Rejections | Upload_Rejections_ID |
| scheduler | Upload_Reviews | Employee_ID |
| scheduler | Upload_Reviews | Message |
| scheduler | Upload_Reviews | Reason |
| scheduler | Upload_Reviews | Review_Date |
| scheduler | Upload_Reviews | Reviewed |
| scheduler | Upload_Reviews | ScheduleID |
| scheduler | Upload_Reviews | Upload_Reviews_ID |
| scheduler | Upload_Transfers | From_Employee_ID |
| scheduler | Upload_Transfers | Message |
| scheduler | Upload_Transfers | Reason |
| scheduler | Upload_Transfers | ScheduleID |
| scheduler | Upload_Transfers | To_Employee_ID |
| scheduler | Upload_Transfers | Transfer_Date |
| scheduler | Upload_Transfers | Upload_Transfers_ID |
| scheduler | User_Access | accountEnabled |
| scheduler | User_Access | change_password_attempts |
| scheduler | User_Access | customerView |
| scheduler | User_Access | Employee_ID |
| scheduler | User_Access | last_access |
| scheduler | User_Access | last_change_password |
| scheduler | User_Access | last_login |
| scheduler | User_Access | last_reset_password |
| scheduler | User_Access | limitedView |
| scheduler | User_Access | login_attempts |
| scheduler | User_Access | User_Access_ID |
| scheduler | User_Access | user_affiliation |
| scheduler | User_Access | user_display_name |
| scheduler | User_Access | user_email |
| scheduler | User_Access | user_first_name |
| scheduler | User_Access | user_last_name |
| scheduler | User_Access | user_message |
| scheduler | User_Access | user_name |
| scheduler | User_Access | user_password |
| scheduler | User_Access | user_phone_number |

As may be seen in the database definition depicted in Table 1, data may be stored and/or accessed from one or more databases, in the exemplary embodiment, impulse database or scheduler database. Each database may further include one or more tables, such as, e.g., but not limited to, an agent table in the impulse database. Each table may further include one or more fields, such as for the scheduler database's User_Access table, the user_password field of the penultimate row of Table 1.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A computer-implemented method of translating intraoperative neurophysiologic monitoring (IONM) data obtained from multiple IONM device types, comprising:
receiving IONM data from at least one IONM device regarding a surgery being monitored;
interacting with an individual to obtain additional information regarding the surgery being monitored;
extracting pertinent information from the IONM data and said additional information; and
translating said pertinent information into translated pertinent information in a platform independent format.

2. The method according to claim 1, further comprising: communicating said translated pertinent information over a network to at least one of a database and/or a user.

3. The method according to claim 2, further comprising:
processing data from said database to produce reporting information.

4. The method according to claim 3, wherein said processing comprises at least one of:
analyzing;
capturing;
correlating;
compiling;
mining;
aggregating;
converting into said platform independent format;
translating the data from a proprietary IONM device specific format to said translated pertinent information in said platform independent format;
accumulating; and/or
augmenting.

5. The method according to claim 3, wherein said processing comprises at least one of:
backoffice processing;
providing information to or obtaining information from accounting systems;
providing information to or obtaining information from billing systems;
providing information to or obtaining information from insurance applications;
providing information to or obtaining information from patient data applications;
providing information to or obtaining information from collections applications;
providing research reports;
providing business research reports;
providing business competitive information;
providing business utilization information; or
providing clinical research report information.

6. The method according to claim 1, further comprising:
reporting said translated pertinent information.

7. The method according to claim 1, wherein said additional information comprises at least one of:
a type of IONM device;
a type of device implanted in a patient;
clinical information;
patient information;
insurance information;
demographic information;
medical record data;
surgeon name;
surgeon information;
physician information;
early outcome data;
preoperative data;
post-operative data;
outcome scales;
outcomes allowed;
IONM event data;
IONM event data tied to preoperative condition;
IONM event data tied to postoperative condition;
baseline data;
IONM baseline data;
anesthesiology data;
scale preoperative data;
scale postoperative data; and/or other information regarding the surgery being monitored.

8. The method according to claim 1, wherein said individual comprises at least one of: a technician; a technologist; a patient; a physician; a surgeon; a provider; a care giver and/or provider; or a medical professional.

9. The method according to claim 1, wherein said translating comprises: translating the information from a format associated with each of the multiple IONM devices types into said platform independent format.

10. A system of translating intraoperative neurophysiologic monitoring (IONM) data obtained from multiple IONM device types, comprising:
means for receiving the IONM data from at least one IONM device regarding a surgery being monitored;
means for interacting with an individual to obtain additional information regarding the surgery being monitored;
means for extracting pertinent information from the IONM data and said additional information; and
means for translating said pertinent information into translated pertinent information in a platform independent format.

11. The system according to claim 10, further comprising
means for reporting said translated pertinent information.

12. A system for receiving, extracting, and translating intraoperative neurophysiologic monitoring (IONM) data from a plurality of IONM devices of different IONM device format types, comprising:
at least one IONM device operable to receive IONM data of a patient regarding a surgery being monitored and performed on the patient;
an extraction module operable to extract the IONM data from said at least one IONM device and operable to translate the IONM data into a translated platform independent format;
a network, coupled to said at least one IONM device, operable to communicate the IONM data; and
a database coupled to said network, wherein said database is operable to perform at least one of storing or accessing the IONM data.

13. The system of claim 12, wherein said individual is located at a location remote from said at least one IONM device.

14. The system of claim 12, wherein said database at least one of stores or accesses the IONM data and is operable to provide semi-automatic reporting.

15. The system of claim 12, wherein the system is further operative to augment the IONM data with additional information comprising at least one of:
patient identifying information,
intraoperative neurophysiologic monitoring event data,
preoperative data,
postoperative data,
demographic data of the patient,
insurance data,
backoffice application information,
accounting information,
supply information,
inventory information,
device information,
collections information,
physician information,
statistical information,
medical facility information,
care provider information, or
billing information.

16. The system in claim 11, further comprising an analysis module operable to analyze the IONM data.

17. A computer program product for translating intraoperative neurophysiologic monitoring (IONM) data from multiple IONM device types, the computer program product embodied on a computer accessible medium, the computer program product including program logic, which when executed on a computer performs a method comprising:
receiving the IONM data from a IONM device;
interacting with an individual to obtain additional information;
extracting pertinent information from the IONM data and the additional information; and
translating the pertinent information into a platform independent format.

18. The computer program product according to claim 17, wherein the method further comprises:
reporting the pertinent information

19. The computer program product according to claim 17, wherein the method further comprises:
communicating said translated pertinent information over a network to a database.

20. The computer program product according to claim 19, wherein the method further comprises processing data from said database to produce reports, comprising at least one of:
a business report;
an accounting report;
a billing report;
an insurance report;
a patient report;
a collections report;
a competitive report;
a utilization report; and/or
a clinical research report.

21. The method according to claim 1, wherein said interacting comprises interacting with an individual remote from the surgery being monitored.

22. A computer-implemented method of translating intraoperative neurophysiologic monitoring (IONM) data obtained from multiple IONM device types, comprising:
receiving at a database coupled to a network, JONM data in a translated platform independent format from an extraction module operable to extract the IONM data from at least one remote IONM device coupled to the network; and
storing the IONM data in the database.
